(19) United States
(12) Patent Application Publication
(10) Pub. No.: US 2012/0182503 A1
(43) Pub. Date: Jul. 19, 2012

(54) LIQUID CRYSTAL DISPLAY ELEMENT AND LIQUID CRYSTAL DISPLAY DEVICE

(76) Inventors: Mitsuhiro Murata, Osaka-shi (JP); Shuichi Kozaki, Osaka-shi (JP); Shoichi Ishihara, Osaka-shi (JP); Takehisa Sakurai, Osaka-shi (JP); Tadashi Ohtake, Osaka-shi (JP); Masako Nakamura, Osaka-shi (JP)

(21) Appl. No.: 13/381,283

(22) PCT Filed: Mar. 9, 2010
(86) PCT No.: PCT/JP2010/001639

§ 371 Date: Feb. 14, 2012

(30) Foreign Application Priority Data
Jul. 1, 2009 (JP) 2009-157132

(51) Int. Cl. G02F 1/1335; G02F 1/1343

(52) U.S. Cl. 349/106; 349/139

(57) ABSTRACT

A liquid crystal display element of the present invention is a vertical alignment type liquid crystal display element (10) comprising an array substrate (22), a counter substrate (24), and a liquid crystal layer (50), which carries out a display by controlling orientations of liquid crystal molecules (52) in the liquid crystal layer (50) by use of transverse electric fields (60). In the liquid crystal display element (10), projections (70) are provided in positions corresponding to boundaries (V1, V2, V3) of orientational regions in the liquid crystal layer (50), on a liquid crystal layer (50) side surface of the counter substrate (24). Each of the protrusions (70) has a taper shape.

### TECHNICAL FIELD

The present invention relates to a liquid crystal display element having an improved response speed and an improved orientational stability.

### BACKGROUND ART

A liquid crystal display device, in which a liquid crystal display element is used as a display section of the liquid crystal display device, is characterized by being thin, light, and low in power consumption and widely used in various fields.

For such a liquid crystal display element, a viewing angle characteristic and a response speed can be exemplified as problems it has to overcome. In the liquid crystal display element, a display characteristic changes in accordance with a viewing angle. This is because the liquid crystal molecules have a rod-like shape. The rod-like shape results in that the liquid crystal display element shows different states of birefringence when viewed from the front and when viewed obliquely.

In view of the above, various techniques have been proposed in order to improve liquid crystal display elements in viewing angle characteristic and response speed.

(Patent Literature 1)

For example, in order to improve a viewing angle characteristic and increase a response speed, Patent Literature 1 discloses such a technique that an insulating layer for changing a direction of an electric field in a pixel region in a case where a voltage is applied between a pair of substrates is provided in each of the pair of substrates.

To improve a viewing angle characteristic etc., various display modes have been proposed, such as a display mode using a transverse electric field and a display mode using vertically aligned liquid crystal molecules, for example.

(Patent Literature 2)

In order that an occurrence of disclination is suppressed and alignment of liquid crystal molecules is stabilized in connection with the aforementioned problem, e.g. Patent Literature 2 below discloses such a technique that projecting structures are provided parallel to bus lines provided on a substrate.

### CITATION LIST

### Patent Literatures

Patent Literature 1

Japanese Patent Application Publication, Tokukai, No. 2000-193977 A (Publication Date: Jul. 14, 2000)

Patent Literature 2

Japanese Patent Application Publication, Tokukai, No. 2008-197691 A (Publication Date: Aug. 28, 2008)

### SUMMARY OF INVENTION

### Technical Problem

However, the conventional techniques have a problem of an insufficient response speed and an insufficient orientational stability. The following deals with this.

Examples of display modes in which a viewing angle characteristic and a response speed can be improved encompass a display mode in which liquid crystal molecules are vertically aligned and driven by transverse electric fields (hereinafter, the mode is also referred to as vertical-alignment transverse-electric-field mode). The following describes this with reference to FIG. 19.

FIG. 19 is a cross-sectional view of a liquid crystal cell, which cross-sectional view illustrates a schematic arrangement of a liquid crystal display element. FIG. 19 exemplifies a liquid crystal display element which vertically aligns liquid crystal molecules and carries out a display by applying transverse electric fields to the liquid crystal molecules. Note that the transverse electric field denotes an electric field which is generated (i) by means of a potential difference generated on a single substrate instead of a potential difference between two substrates facing each other and (ii) mainly in a direction parallel to the single substrate.

As illustrated in FIG. 19, the liquid crystal cell 14 in the liquid crystal display element 10 of a vertical-alignment transverse-electric-field mode has a configuration in which a liquid crystal layer 50 containing liquid crystal molecules 52 is sandwiched between an array substrate 22 and a counter substrate 24, which are two substrates facing each other.

Further, the array substrate 22 is provided with interleaved electrodes 30. Specifically, three interleaved electrodes (first interleaved electrode 30a, second interleaved electrode 30b, and third interleaved electrode 30c) are provided in each of unit regions 12 in order of the first interleaved electrode 30a, the second interleaved electrode 30b, and the third interleaved electrode 30c. The unit regions 12 are simulated regions for describing the present invention, and are regions each of which contains four orientational regions to be described later.

Note that the number of the interleaved electrodes 30 provided to each of the pixels is not limited to a specific one and can be determined appropriately in accordance with, for example, a pitch between the plurality of pixels, and a line/space width of the electrodes. Accordingly, one unit region 12 and one pixel correspond to each other in such an arrangement that, e.g., the three interleaved electrodes (first interleaved electrode 30a, second interleaved electrode 30b, and third interleaved electrode 30c) are provided in each of the pixels, as the interleaved electrodes 30. However, each of the unit regions 12 does not always correspond to one pixel.

The first interleaved electrode 30a and the third interleaved electrode 30c have usually an identical electric potential. On the other hand, a potential difference is caused between the first interleaved electrode 30a and the second interleaved electrode 30b, and between the third interleaved electrode 30c and the second interleaved electrode 30b. Due to the potential difference, one of electric fields 60 is generated between the first interleaved electrode 30a and the second interleaved electrode 30b, and the other one of the electric fields 60 is generated between the second interleaved electrode 30b and the third interleaved electrode 30c.

In a case where none of the electric fields 60 is generated, namely, the liquid crystal display element 10 is OFF (i.e., no voltage is applied), the liquid crystal molecules 52 in the liquid crystal display element 10 are aligned vertically to the array substrate 22 and the counter substrate 24 because the liquid crystal display element 10 is one of the vertical-alignment transverse-electric-field mode.

In a case where the liquid crystal display element 10 is turned on (voltage is applied) so that the electric fields 60 are generated, the liquid crystal molecules 52 which are vertically aligned change their orientations (directors) along the transverse electric fields 60 thus generated.

FIG. 19 illustrates such a state that a voltage is applied to the liquid crystal display element 10. The description above exemplifies a case where a dielectric anisotropy of the liquid crystal molecules 52 is positive. As illustrated in FIG. 19, some of the liquid crystal molecules 52 are still vertically aligned even in a case where a voltage is applied to the liquid crystal display element 10. Specifically, a part of the liquid crystal molecules 52 which is located at a position above a center of each of the interleaved electrodes 30, and a part of the liquid crystal molecules 52 which is located at a position corresponding to a center between two adjacent ones of the interleaved electrodes 30.

More specifically, a first vertically-aligned part V1 is caused at a position on a center line of the first interleaved electrode 30a, a second vertically-aligned part V2 is caused at a position on a center line of the second interleaved electrode 30b, and a third vertically-aligned part V3 is caused at a position on a center line of the third interleaved electrode 30c.

Further, a fourth vertically-aligned part V4 is caused at a position on a center line between the first interleaved electrode 30a and the second interleaved electrode 30b, and a fifth vertically-aligned part V5 is caused at a position on a center line between the second interleaved electrode 30b and the third interleaved electrode 30c.

In other words, the vertically-aligned parts V1, V2 and V3 are caused in respective positions on center lines of line ranges (first line range L1 corresponding to first interleaved electrode 30a, second line range L2 corresponding to second interleaved electrode 30b, and third line range L3 corresponding to third interleaved electrode 30c) in which the interleaved electrodes 30 are provided. On the other hand, the vertically-aligned parts V4 and V5 are caused in respective positions on center lines of space ranges (first space range S1 between first interleaved electrode 30a and second interleaved electrode 30b, second space range S2 between second interleaved electrode 30b and third interleaved electrode 30c) in which no interleaved electrodes 30 are provided.

A region sandwiched between adjacent two of the vertically-aligned parts serves as an orientational region. The unit region 12 illustrated in FIG. 19 contains the following four orientational regions in total, (i) a first orientational region R1 sandwiched between a first vertically-aligned part V1 of the liquid crystal molecules 52 and a fourth vertically-aligned part V4 of the liquid crystal molecules 52, (ii) a second orientational region R2 sandwiched between the fourth vertically-aligned part V4 and a second vertically-aligned part V2 of the liquid crystal molecules 52, (iii) a third orientational region R3 sandwiched between the second vertically-aligned part V2 and a fifth vertically-aligned part V5 of the liquid crystal molecules 52, and (iv) a fourth orientational region R4 sandwiched between the fifth vertically-aligned part V5 and the third vertically-aligned part V3 of the liquid crystal molecules 52.

That is, in a case where a voltage is applied to the liquid crystal display element 10 so that a voltage is applied to the liquid crystal molecules 52, vertically-oriented parts of the liquid crystal molecules 52 serve as boundaries of the four orientational regions, respectively.

The vertically-aligned parts are so-called disclination lines (domain boundaries), and are likely to be observed as dark lines in a case where a voltage is applied to the liquid crystal display element 10. In particular, the fourth vertically-aligned part V4 in the first space range S1 and the fifth vertically-aligned part V5 in the second space range S2 are likely to be observed as dark lines. This is described with reference to (a) and (b) of FIG. 20.

FIG. 20 is a view illustrating the unit region 12 of the liquid crystal display element 10 from above. (a) of FIG. 20 illustrates a state where no voltage is applied to the liquid crystal display element 10. (b) of FIG. 20 illustrates a state where a voltage is applied to the liquid crystal display element 10.

As illustrated in (a) of FIG. 20, black display is carried out in the whole of the unit region 12 in a case where no voltage is applied to the liquid crystal display element 10. In a case where a voltage is applied to the liquid crystal display element 10, white display is carried out in the unit region 12, as illustrated in (b) of FIG. 20.

As illustrated in (b) of FIG. 20, the fourth vertically-aligned part V4 in the first space range S1 and the fifth vertically-aligned part V5 in the second space range S2 are observed as first dark line D1 and a second dark line D2, respectively.

In some cases, the first dark line D1 and the second dark line D2 are not straight lines such as those illustrated in (b) of FIG. 20, but are wavy lines.

(Orientational Stability)

FIG. 21 is a view illustrating an image displayed by the liquid crystal display element 10 in a case where a voltage is applied to the liquid crystal display element 10.

As shown in FIG. 21, the first dark line D1 and the second dark line D2 look wavy lines.

The wavy dark lines are attributed to unstable orientations of the liquid crystal molecules 52 in the vicinity of the fourth vertically-aligned part V4 in which the first dark line arises and in the vicinity of the fifth vertically-aligned part V5 in which the second dark line D2 arises.

(Response Speed)

In an area where the liquid crystal molecules 52 have the unstable orientations, the liquid crystal molecules 52 are likely to have irregular directors. The irregular directors lead to a problem in that a response speed of the liquid crystal display element 10 is likely to be slow. This is because in a case where the directors of the liquid crystal molecules 52 are irregular, the liquid crystal molecules 52 cannot move smoothly when an electric field is changed.

Although the technique disclosed in Patent Literature 2 aims at suppression of an occurrence of disclination, the technique assumes driving by use of vertical electric fields to be caused between opposed substrates. Therefore, the liquid crystal display element 10 of the vertical-alignment transverse-electric-field mode does not make it possible to obtain a desired effect.

Further, although the technique disclosed in Patent Literature 1 aims at increasing a response speed, the technique assumes driving by use of vertical electric fields, as is the case with Patent Literature 2. Therefore, even if the technique is applied to the liquid crystal display element 10 of the vertical-alignment transverse-electric-field mode, a desired effect cannot be obtained.

Thus, the conventional techniques do not make it possible to obtain a liquid crystal display element having an improved viewing angle characteristic, an improved orientational stability, and an improved response speed.

The present invention was made to solve the problems. An object of the present invention is to provide a liquid crystal display element and a liquid crystal display device each of which has an improved viewing angle characteristic, an improved orientational stability, and an improved response speed.

### Solution to Problem

In order to attain the object, a liquid crystal display element of the present invention is a liquid crystal display element, which is a vertical alignment type liquid crystal display element including a pair of substrates, and a liquid crystal layer containing liquid crystal molecules, the liquid crystal layer being sandwiched between the substrates and being configured to carry out display operation by controlling orientations of the liquid crystal molecules in the liquid crystal layer by use of transverse electric fields, comprising: projections being provided in respective positions on a liquid crystal layer-side surface of at least one of the substrates, the respective positions corresponding to boundaries of orientational regions in the liquid crystal layer, each of said projections having a taper shape.

According to the arrangement, the projections each having a taper shape are provided in respective positions corresponding to the boundaries of the orientational regions on which boundaries liquid crystal molecules are vertically aligned when a voltage is applied to the liquid crystal molecules.

(Response Speed)

This makes it possible to increase a response speed in at least one of a rise and a fall of a liquid crystal display element of the vertical-alignment transverse-electric-field mode.

That is, in a case where the protrusions having a taper shape are provided in respective positions corresponding to the boundaries of the orientational regions, the liquid crystal molecule in the vicinity of the projections are oriented along the inclined side surfaces of the projections. As a result, the liquid crystal molecules are likely to have a uniform orientation.

Accordingly, the liquid crystal molecules are likely to start moving at a same timing in the rise. This increases a response speed. As for the fall, the liquid crystal molecules are likely to have stable orientations after their movement ends. This increases a response speed.

(Orientational Stability)

Further, the arrangement makes it possible to improve orientational stability, and thereby prevent a disclination line to be observed as a dark line from becoming a wavy line.

That is, in a case where a transverse electric field is applied to the liquid crystal molecules in the liquid crystal display element of the vertical-alignment transverse-electric-field mode, orientations of the liquid crystal molecule are axisymmetrically displaced with respect to a symmetric axis which is a center line (usually, a center line between two adjacent electrodes) of the transverse electric field. Therefore, liquid crystal molecules on one side of the symmetrical axis and liquid crystal molecules on the other side push against each other in the vicinity of the center line so that a director is likely to vary between liquid crystal molecules which face each other across the symmetrical axis. As a result, the liquid crystal molecules have irregular orientations. This can lead to a decrease in orientational stability.

A dark line which is usually observed in the vicinity of the center line in the liquid crystal display element of the vertical-alignment transverse-electric-field mode can become a wavy line due to the decrease in orientational stability in the vicinity of the center line. This can lead to a deterioration in display quality,

According to the aforementioned arrangement, as described above, the liquid crystal molecules are likely to start moving at a same timing when a voltage is applied to the liquid crystal molecules. Therefore, in the vicinity of the center line where the liquid crystal molecules face each other which liquid crystal molecules stand up from different directions, a director is unlikely to vary between liquid crystal molecules which face each other across the symmetrical axis. This improves an orientational stability of the liquid crystal molecules in the vicinity of the liquid crystal molecules. As a result, the dark line is likely to be not a wavy line but a straight line.

Further, in a case where the arrangement above remedies irregularity of orientations of the liquid crystal molecules which irregularity is likely to occur when an voltage is applied, a response speed is increased further.

That is, a decrease in orientational stability in the vicinity of the center line indicates that it takes a long time until movement of the liquid crystal molecules ends. This leads to a decrease in response speed. With regard to this, in a case where the orientations of the liquid crystal molecules become likely to be stabilized in the vicinity of the center line, movement in a rise of the liquid crystal molecules is likely to end earlier. This further increases a response speed.

Thus, since the liquid crystal display element thus arranged is one of the vertical-alignment transverse-electric-field mode, the liquid crystal display element has a good viewing angle characteristic, and further, both of a good orientational stability and a good response speed.

The taper shape refers to a sloped shape. For example, each of the projections have a such a shape that its cross-section and its bore diameter decrease from its base to its tip.

### Advantageous Effects of Invention

As described above, the liquid crystal display element of the present invention is arranged such that projections are provided in respective positions on a liquid crystal layer-side surface of at least one of said first substrate and said second substrate, the respective positions corresponding to boundaries of orientational regions in said liquid crystal layer, each of said projections having a taper shape.

This makes it possible to provide a liquid crystal display element having an improved viewing angle characteristic, an improved orientational stability, and an improved response speed.

### BRIEF DESCRIPTION OF DRAWINGS

FIG. 1 is a cross-sectional view illustrating a schematic arrangement of a liquid crystal display element of an embodiment of the present invention.

FIG. 2 is a cross-sectional view illustrating a schematic arrangement of a liquid crystal display element.

FIG. 3 is a cross-sectional view illustrating a schematic arrangement of a liquid crystal display element.

FIG. 4 is a table showing characteristics of liquid crystal display elements.

FIG. 5 is a view illustrating a liquid crystal display element of a second comparative example. (a) of FIG. 5 illustrates orientations of liquid crystal molecules. (b) of FIG. 5 illustrates how a dark line looks.

FIG. 6 is a view illustrating a liquid crystal display element of the present embodiment. (a) of FIG. 6 illustrates orientations of liquid crystal molecules. (b) of FIG. 6 illustrates how a dark line looks.

FIG. 7 is a view illustrating orientations of liquid crystal molecules in the vicinity of a disclination line.

FIG. 8 is a cross-sectional view illustrating a schematic arrangement of a liquid crystal display element of a second embodiment of the present invention.

FIG. 9 is a view illustrating orientations of liquid crystal molecules. (a) of FIG. 9 illustrates the second embodiment of the present invention. (b) of FIG. 9 illustrates the first embodiment of the present invention. (c) of FIG. 9 illustrates a second comparative example.

FIG. 10 is a cross-sectional view illustrating a schematic arrangement of a liquid crystal display element of a third embodiment of the present invention.

FIG. 11 is a cross-sectional view illustrating a schematic arrangement of a liquid crystal display element of a fourth embodiment of the present invention.

FIG. 12 is a cross-sectional view illustrating a schematic arrangement of a liquid crystal display element of a fifth embodiment of the present invention.

FIG. 13 is a cross-sectional view illustrating a schematic arrangement of a liquid crystal display element of a sixth embodiment of the present invention.

FIG. 14 is a view illustrating the first embodiment of the present invention. (a) of FIG. 14 illustrates a schematic arrangement of the liquid crystal display element. (b) of FIG. 14 illustrates simulated orientations of liquid crystal molecules.

FIG. 15 is a view illustrating the second and fifth embodiments of the present invention. (a) of FIG. 15 illustrates a schematic arrangement of the liquid crystal display element. (b) of FIG. 15 illustrates simulated orientations of liquid crystal molecules.

FIG. 16 is a view illustrating the third embodiment of the present invention. (a) of FIG. 16 illustrates a schematic arrangement of the liquid crystal display element. (b) of FIG. 16 illustrates simulated orientations of liquid crystal molecules.

FIG. 17 is a view illustrating the fourth and sixth embodiments of the present invention. (a) of FIG. 17 illustrates a schematic arrangement of the liquid crystal display element. (b) of FIG. 17 illustrates simulated orientations of liquid crystal molecules.

FIG. 18 is a view illustrating a first comparative example. (a) of FIG. 18 illustrates a schematic arrangement of the liquid crystal display element. (b) of FIG. 18 illustrates simulated orientations of liquid crystal molecules.

FIG. 19 is a cross-sectional view illustrating a schematic arrangement of a liquid crystal display element.

FIG. 20 is a view illustrating a unit region. (a) of FIG. 20 illustrates a state where no voltage is applied. (b) of FIG. 20 illustrates a state where a voltage is applied.

FIG. 21 is a view illustrating an image displayed by the liquid crystal display element in a case where a voltage is applied to the liquid crystal display element.

### DESCRIPTION OF EMBODIMENTS

### First Embodiment

The following describes an embodiment of the present invention, with reference to FIG. 1 etc.

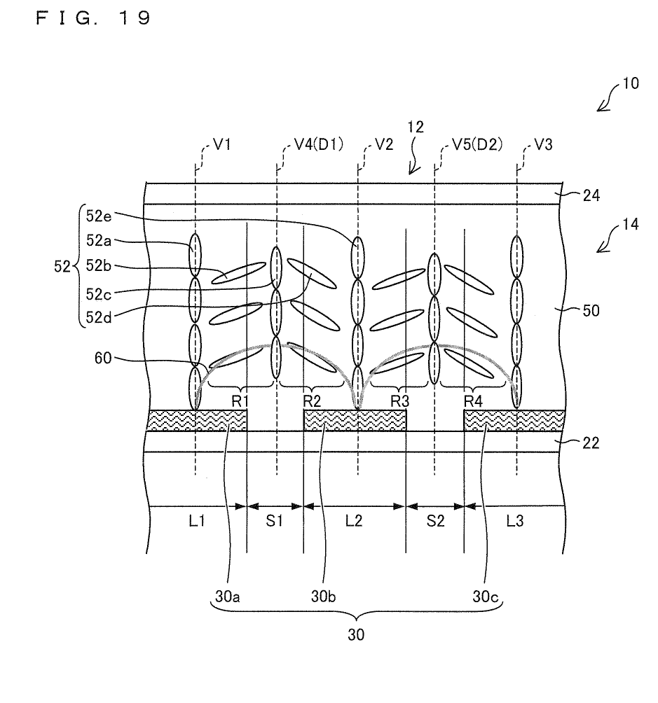

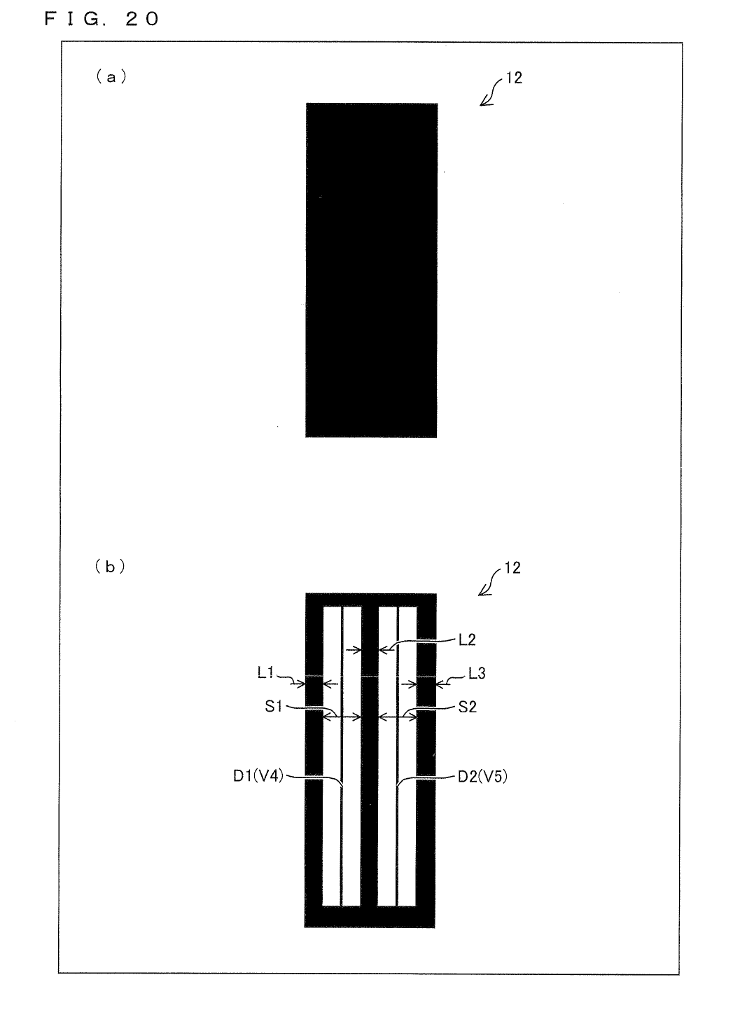

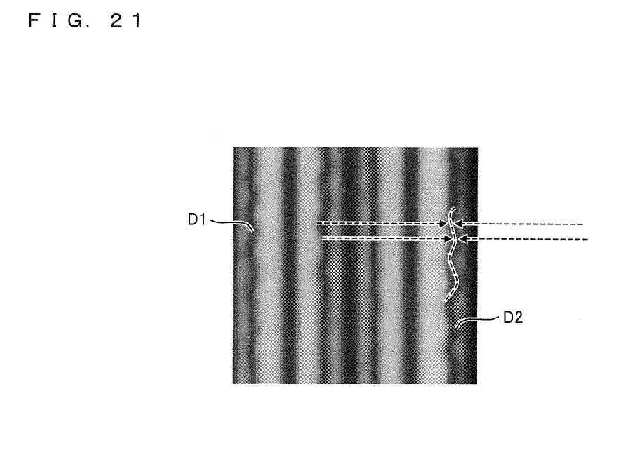

FIG. 1 is a view illustrating a schematic arrangement of a liquid crystal display element 10 of the present embodiment which liquid crystal display element 10 can be employed as a display section of a liquid crystal display device such as a liquid crystal television. As is the case with FIG. 19, specifically, FIG. 1 illustrates a cross-section of the liquid crystal display element 10, with regard to one of unit regions 12 each of which contains four orientational regions. Note that pixels provided in a matrix pattern in the liquid crystal display element 10 and the unit regions 12 do not necessarily correspond one to one to each other. However, in a case where, e.g., each of the pixels contains four orientational regions, each of the pixels and one of the unit regions 12 correspond to each other.

The liquid crystal display element 10 of the present embodiment has a substantially same arrangement as the liquid crystal display element 10 which has been described with reference to FIG. 19.

That is, the liquid crystal display element 10 of the present embodiment is arranged to be a liquid crystal display element 10 of a vertical-alignment transverse-electric-field mode. Specifically, in a case where no voltage is applied to the liquid crystal display element 10, liquid crystal molecules 52 are aligned vertically. In a case where a voltage is applied to the liquid crystal display element 10, transverse electric fields are applied to the liquid crystal molecules 52. As a result, a main part of the liquid crystal molecules 52 have a nearly horizontal orientation.

The explanation above is based on a case where the liquid crystal molecules 52 have positive dielectric anisotropy. However, the dielectric anisotropy of the liquid crystal molecules 52 is not required to be positive. That is, it is possible to employ liquid crystal molecules 52 having negative dielectric anisotropy.

The following describes the schematic arrangement of the liquid crystal display element 10 in more detail, with reference to FIG. 1. FIG. 1 is a view illustrating the schematic arrangement of the liquid crystal display element 10 of the present embodiment.

As illustrated in FIG. 1, a liquid crystal cell 14 of the liquid crystal display element 10 of the vertical-alignment transverse-electric-field mode is arranged such that a liquid crystal layer 50 which contains the liquid crystal molecules 52 is sandwiched between an array substrate 22 and a counter substrate 24 which are two opposed substrates.

Further, columnar spacers 16 are provided between the array substrate 22 and the counter substrate 24. As is the case with FIG. 19, FIG. 1 illustrates a simulated region for explaining the present embodiment. Specifically, FIG. 1 illustrates one of the unit regions 12 which contains the four orientational regions. In the liquid crystal display element 10 exemplified in FIG. 1, two columnar spacers 16 are provided in each of the unit regions 12. A region defined by such two adjacent ones of the columnar spacers 16 is one of the unit regions 12.

The following describes electrodes. Interleaved electrodes 30 are provided on the array substrate 22. Specifically, three interleaved electrodes (first interleaved electrode 30a, second interleaved electrode 30b, and third interleaved electrode 30c) are provided in each of the unit regions 12 in order of the first interleaved electrode 30a, the second interleaved electrode 30b, and the third interleaved electrode 30c.

One of the transverse electric fields is generated between the first interleaved electrode 30a and the second interleaved electrode 30b, and the other one of the transverse electric fields is generated between the second interleaved electrode 30b and the third interleaved electrode 30c. Curved lines 60 illustrated in FIG. 1 indicate approximate lines of electric forces of the transverse electric fields.

(Orientational Regions)

The following describes the orientational regions. As described above, each of the unit regions 12 contains four orientational regions.

“Orientational region” refers to a region sandwiched between two adjacent vertically-aligned parts of the liquid crystal molecules 52. The unit region 12 illustrated in FIG. 1 contains the following four orientational regions in total, (i) a first orientational region R1 sandwiched between a first vertically-aligned part V1 of the liquid crystal molecules 52 and a fourth vertically-aligned part V4 of the liquid crystal molecules 52, (ii) a second orientational region R2 sandwiched between the fourth vertically-aligned part V4 and a second vertically-aligned part V2 of the liquid crystal molecules 52, a third orientational region R3 sandwiched between the second vertically-aligned part V2 and a fifth vertically-aligned part V5 of the liquid crystal molecules 52, and (iv) a fourth orientational region R4 sandwiched between the fifth vertically-aligned part V5 and the third vertically-aligned part V3 of the liquid crystal molecules 52.

In a case where a voltage is applied to the liquid crystal display element 10 so that the voltage is applied to the liquid crystal molecules 52, vertically-oriented parts of the liquid crystal molecules 52 serve as boundaries of the four orientational regions, respectively.

In the liquid crystal display element 10, pixels are provided in a matrix pattern. The number of the interleaved electrodes 30 to be provided in each of the pixels is not particularly limited. For example, the number is freely determined in accordance with a pixel pitch, a line/space width of electrodes, etc. As stated above, therefore, the unit regions 12 and the pixels do not necessarily correspond one to one to each other.

(Protrusions)

The liquid crystal display element 10 of the present embodiment is characterized in that protrusions are provided in respective positions on the counter substrate 24 which positions correspond to boundaries of orientational regions in the liquid crystal layer 50. Specifically, sloping protrusions 70 each of which has a shape of a truncated cone are provided in the liquid crystal cell 14.

It is not necessarily required to provide the sloping protrusions in positions corresponding to all the boundaries of the orientational regions. Although the following describes this on the basis of embodiments, for example, each of the sloping protrusions 70 can be provided (i) at a position corresponding to a boundary of two adjacent ones of the orientational regions which correspond to one of the interleaved electrodes 30 or (ii) at a position corresponding to a boundary of two adjacent ones of the orientational regions which correspond to adjacent two of the interleaved electrodes 30. The following describes this in detail.

As illustrated in FIG. 1, above-electrode sloping protrusions 70a are provided as the sloping protrusions 70 in such positions that the above-electrode sloping protrusions 70a overlap the interleaved electrodes 30 when viewed from above, on a surface of the counter substrate 24 which surface faces the liquid crystal layer 50.

Specifically, three above-electrode sloping protrusions 70a are provided in total in respective positions on the counter substrate 24 which positions correspond to the three interleaved electrodes 30 provided in the unit region 12, the first interleaved electrode 30a, the second interleaved electrode 30b, and the third interleaved electrode 30c.

More specifically, each of the above-electrode sloping protrusions 70a has a rectangular shape when viewed from above. The above-electrode sloping protrusions 70a are provided along the interleaved electrodes 30. Further, each of the above-electrode sloping protrusions 70a is provided at a position which corresponds to a substantial center of a line width of a corresponding one of the interleaved electrodes 30 when viewed from above.

Each of the above-electrode sloping protrusions 70a has a trapezoidal cross-sectional shape along a plane orthogonal to a direction in which the interleaved electrodes 30 extend. Specifically, two parallel sides of the trapezoidal cross-sectional shape are parallel to the counter substrate 24, and one of the two parallel sides which is closer to the counter substrate 24 is longer than the other one of the two parallel sides. FIG. 1 shows a case where the trapezoidal cross-sectional shape is an isosceles trapezoid, and a lower base of the trapezoidal cross-sectional shape is the one of the two parallel sides which is closer to the counter substrate 24.

As described above, the liquid crystal display element 10 of the present embodiment is arranged such that the above-electrode sloping protrusions 70a each of which has a so-called taper shape are provided within the liquid crystal cell 14. The taper shape narrows as distance from the counter substrate 24 increases.

A side surface of the taper shape does not necessarily have to be smooth, but can have some surface irregularities.

A material for the above-electrode sloping protrusions 70a does not necessarily have to be a transparent material but can be a colored one as necessary, although this is mentioned later.

(Manufacturing Method)

The following describes a method for manufacturing the liquid crystal display element 10. The following explanation is merely an example of a manufacturing method. Therefore, it is possible to appropriately vary each of processes, designed values, etc.

First, a film of ITO is formed to a thickness of 1400 Å by sputtering on an entire surface of a glass substrate which serves as the array substrate 22. Then, the interleaved electrodes 30 made from ITO each of which has an electrode width (line) of 4.0 μm and an electrode interval (space) of 4.0 μm are formed from the film of ITO by photolithography. Thus, the interleaved electrodes 30 are formed so that each of a first line range L1, a second line range L2, and a third line range L3 is 4.0 μm, and each of a first space range S1 and a second space range S2 is 4.0 μm.

Then, an alignment-film coating material manufactured by JSR Corp. (product name: JALS-204 (5 wt. %, gamma-butyrolactone solution)) is applied onto the interleaved electrodes 30 by spin coating, and then baked for 2 hours at 200° C.

Further, an acrylic photosensitive photospacer (columnar spacer) material manufactured by JSR Corp. is applied by spin coating onto an entire surface of the glass substrate which serves as the counter substrate 24 which is a substrate opposed to the array substrate 22.

Then, the acrylic photosensitive photospacer material applied onto the entire surface of the glass substrate is formed into a desired shape by photolithography. Thus, the columnar spacers 16 and the sloping protrusions 70 are formed.

Specifically, the columnar spacers 16 for controlling cell thickness are formed so as to have a height of 3.4 μm. The sloping protrusions 70 are formed so as to have a height of 0.5 μm and a taper angle of 15°.

The “taper angle” refers to an angle formed, as indicted by θ in FIG. 1., between a direction perpendicular to a substrate (counter substrate 24) and each of two directions in which two inclined planes of each of the sloping protrusions 70 extend.

A mesh size of a photomask which is used in forming the photosensitive photospacer by photolithography varies between parts corresponding to the columnar spacers 16 and parts corresponding to the sloping protrusions 70. This makes it possible to vary an exposure amount for the photosensitive photospacer between the parts corresponding to the columnar spacers 16 and the parts corresponding to the sloping protrusions 70. This makes it easy to separately form the columnar spacers 16 and the sloping protrusions 70.

Then, the alignment-film coating material manufactured by JSR Corp. (product name: JALS-204 (5 wt. %, gamma-butyrolactone solution)) is applied onto the counter substrate 24 (including the sloping protrusions 70. The same applies to the following) by spin coating, and then baked for 2 hours at 200° C.

Each of an alignment film on the array substrate 22 and an alignment film on the counter substrate 24 has a thickness of 1000 Å.

Then, a sealing resin manufactured by Mitsui Toatsu Chemicals, Inc. (product name: STRUCTBOND XN-21S) is printed on the counter substrate 24, and then, the counter substrate 24 is attached to the array substrate 22. Then, the counter substrate 24 and the array substrate 22 thus attached to each other are baked for 1 hour at 135° C. Thus, the liquid crystal cells 14 are fabricated into which liquid crystal has not been injected yet.

Then, a positive type liquid crystal material (Δ∈=22, Δn=0.1) manufactured by Merck Ltd. is injected into the liquid crystal cells 14 by a liquid crystal filling vacuum injection method. Then, a polarization plate is attached to the liquid crystal cells 14 so that the liquid crystal display element 10 is fabricated.

(Taper Angle)

A shape and a material for the sloping protrusions 70, e.g., a height and a taper angle of the sloping protrusions 70, a transparency and a dielectric constant of the material, etc. are not particularly limited but can be altered in various ways.

For example, the taper angle can be determined within the range 0°<θ≦45°.

The larger the taper angle, the higher the effects brought by provision of the sloping protrusions 70 such as an effect of improving a response speed (the effect is to be described later), and particularly in the present embodiment, an effect of improving a response speed in a rise.

On the other hand, the taper angle is preferably nearly 45° in order that the provision of the sloping protrusions 70 less affects an orientation of liquid crystal molecules 52 in regions lateral to the sloping protrusions 70, namely, in the vertically-aligned parts where the liquid crystal molecules 52 are vertically oriented in the case of initial alignment and in a case where a voltage is applied to the liquid crystal display element 10.

Further, in consideration of suppression of a decrease in contrast, the following ranges are preferable. The following describes this.

In a case where the initial alignment of the liquid crystal molecules 52 in the liquid crystal display element 10 of a vertical alignment mode, i.e., an alignment direction of the liquid crystal molecules 52 in a case where no voltage is applied to the liquid crystal display element 10 is inclined from a vertical direction, light leakage is likely to occur due to an effect which is the same as one to be produced in such a state that the liquid crystal molecules 52 seemingly stand up with respect to a polarization axis compensation, i.e., in such a state that an electric field is applied to a part of the liquid crystal molecules 52 other than the vertically-oriented parts.

In other words, liquid crystal molecules 52 around the sloping protrusion 72 are inclined from the vertical direction. Accordingly, light leaks from such a part. The light leakage indicates that light leaks from such a part in a case where no voltage is applied to the liquid crystal display element 10. This causes a decrease in contrast.

In a case where no sloping protrusion 72 is provided and a contrast obtained in a case where the liquid crystal molecules 52 are vertically aligned in the initial alignment is 100%, a taper angle (θ) is preferably determined within the range 0°<θ<6°, in order that a contrast of not less than 90%.

Further, in order that a contrast of 80% is obtained which makes it possible to suitably use the liquid crystal display element 10 as a display device, a taper angle (θ) is preferably determined within the range 6°≦θ≦25°.

Further, two straight lines extended from two inclined planes of each of the sloping protrusions 72 preferably intersect with each other on a boundary of two corresponding orientational regions. This helps the taper shape of each of the sloping protrusions 70 to be symmetric with respect to a symmetric axis which is a boundary of two corresponding orientational regions. This makes it possible to suppress irregularity in orientation of the liquid crystal molecules 52 in the vicinity of the sloping protrusions 70 which irregularity is caused by the provision of the sloping protrusions 70.

(Height of Protrusions)

Further, a height of the sloping protrusions 70 is not particularly limited since the sloping protrusions 70 are formed in regions where an orientation of the liquid crystal molecules 52 is unlikely to change.

However, the height of the sloping protrusions 70 is preferably not lower than 0.5 μm, in order that a sufficient effect is obtained from the provision of the sloping protrusions 70.

On the other hand, an upper limit of the height of the sloping protrusions 70 is preferably up to half of a thickness of the liquid crystal cell 14 since exposure conditions are reduced to half in many cases which exposure conditions are employed in a case where, e.g., the sloping protrusions 70 and the columnar spacers 16 are simultaneously formed. Specifically, in a case where a height of the columnar spacers 16, namely, a thickness of the liquid crystal cell 14 is 3.4 μm, the height of the sloping protrusions 70 is preferably not greater than 1.7 μm.

### First Comparative Example

The following shows two types of liquid crystal display elements 100, as comparative examples to be compared with the liquid crystal display element 10 of the first embodiment in terms of their characteristics.

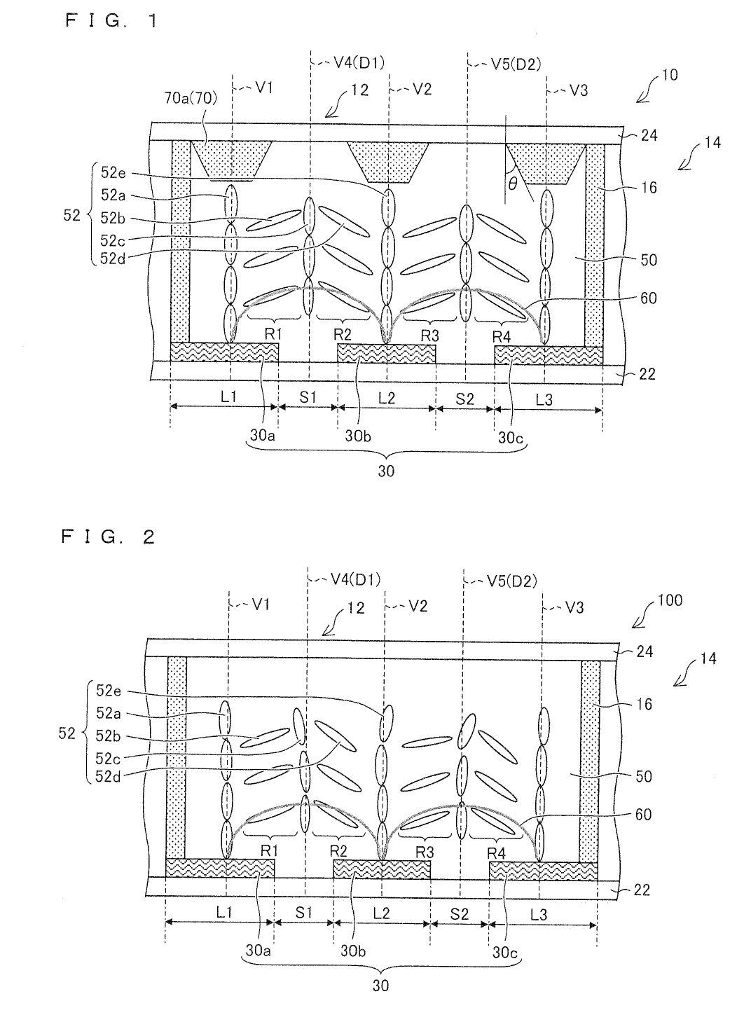

FIG. 2 is a cross-sectional view illustrating a schematic arrangement of a liquid crystal display element 100 of a first comparative example.

The liquid crystal display element 100 illustrated in FIG. 2 has an arrangement which is substantially same as that of the liquid crystal display element 10 which has described with reference to FIG. 19. The liquid crystal display element 100 illustrated in FIG. 2 is different from the liquid crystal display element 10 illustrated in FIG. 19 in that columnar spacers 16 are provided in each of liquid crystal cells 14. That is, as illustrated in FIG. 2, two columnar spacers 16 are provided at both ends of each of unit regions 12 of the liquid crystal display element 100 of the first comparative example.

### Second Comparative Example

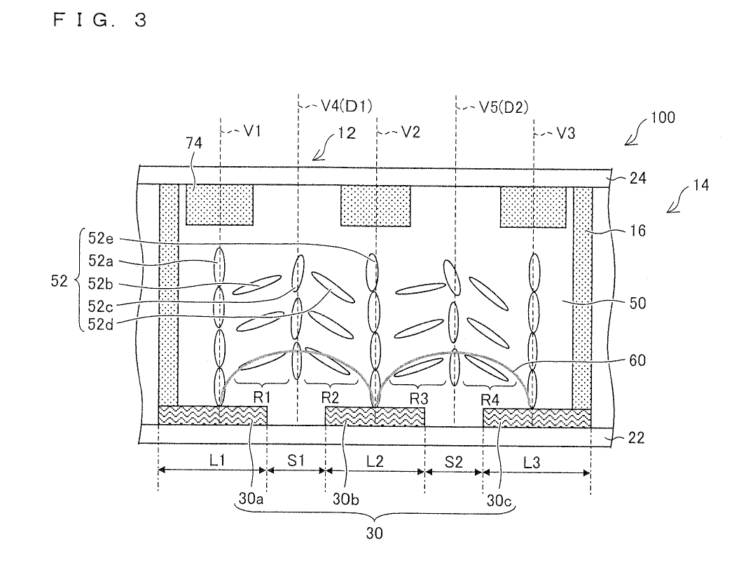

The following describes a liquid crystal display element 100 of a second comparative example, with reference to FIG. 3. FIG. 3 is a cross-sectional view illustrating a schematic arrangement of the liquid crystal display element 100 of the second comparative example.

As illustrated in FIG. 3, the liquid crystal display element 100 of the second comparative example is arranged in the same manner as the liquid crystal display element 10 of the first embodiment in that projections are provided on a counter substrate 24. However, the projections are different in their shape from the sloping projections 70.

As illustrated in FIG. 3, namely, the projections in the second comparative example are rectangular projections 74 each of which has a rectangular cross-sectional shape on a plane orthogonal to a direction in which interleaved electrodes 30 extend.

Each of the sloping protrusions 70 which are projections provided in the liquid crystal display element 10 of the aforementioned first embodiment has a trapezoidal cross-sectional shape, and two inclined side surfaces of each of the sloping protrusions 70 form a so-called taper shape. In contrast, each of the rectangular projections 74 in the liquid crystal display element 100 of the second comparative example has two side surfaces which are substantially perpendicular to the counter substrate 24. Accordingly, the two side surfaces do not form a taper shape.

(Orientational Stability)

The following compares characteristics of the liquid crystal display element 10 of the present embodiment with those of the first and second comparative examples.

The liquid crystal display element 10 of the present embodiment has an improved orientational stability and an improved response speed, as compared with the first and second comparative examples. The following first deals with the orientational stability.

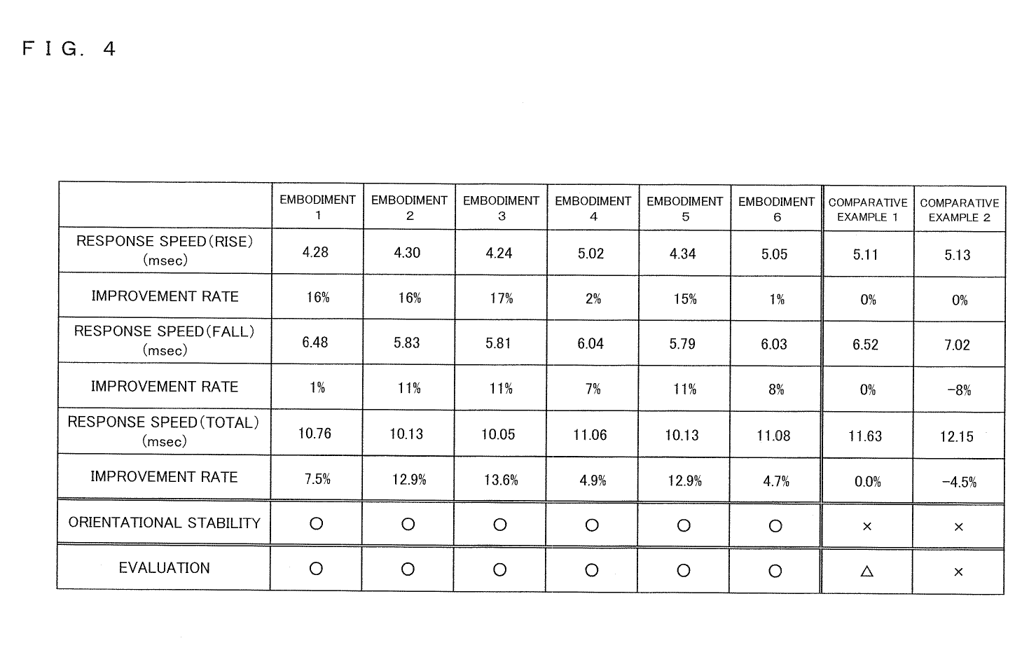

FIG. 4 is a table showing the characteristics of the liquid crystal display element 10. Specifically, FIG. 4 shows evaluation results of response speeds and an orientational stability, for each of liquid crystal display elements.

As shown in FIG. 4, the liquid crystal display element 10 of the present embodiment has an improved orientational stability. An orientational stability was evaluated on the basis of whether a dark line is a straight line or a wavy line. In FIG. 4, “∘” indicates a case where a dark line is a straight line and “x” indicates a case where a dark line is a wavy line.

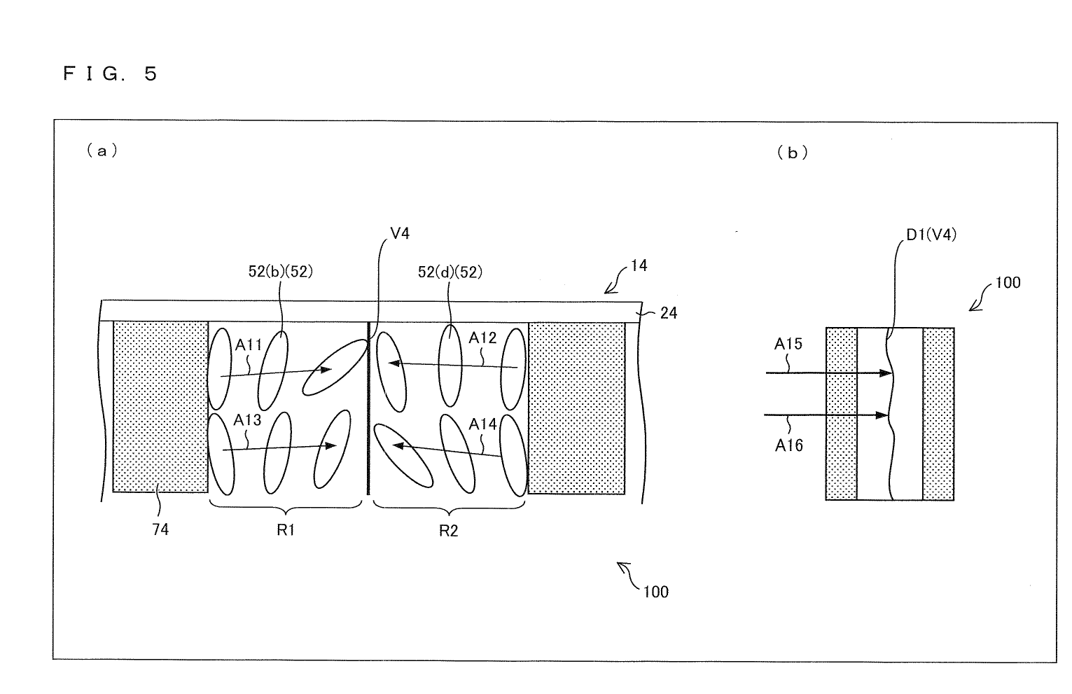

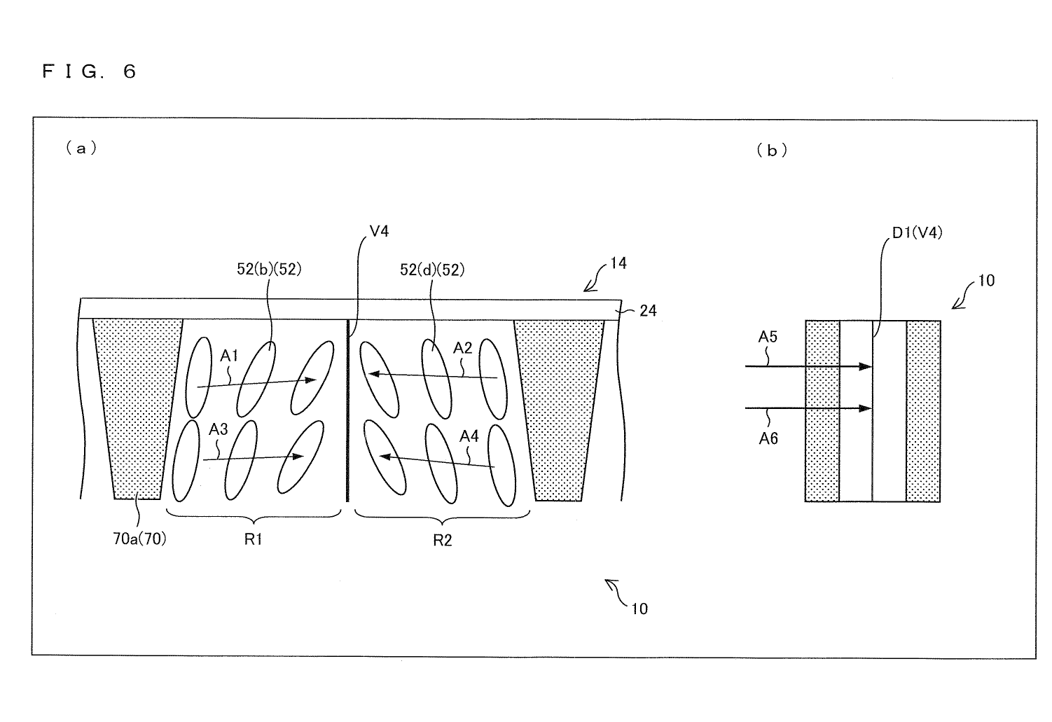

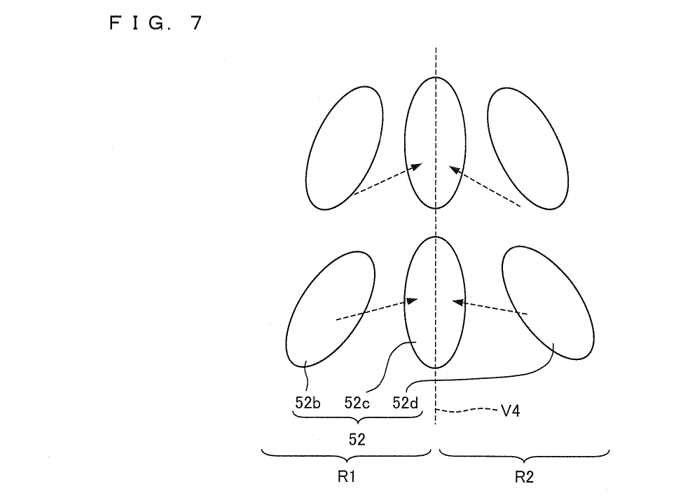

The following describes a reason why a dark line is a straight line or a wavy line, with reference to (a) and (b) of FIG. 5, and (a) and (b) of FIG. 6.

### Second Comparative Example

(a) and (b) of FIG. 5 are views illustrating the liquid crystal display element 100 of the second comparative example. (a) of FIG. 5 is a view illustrating how the liquid crystal molecules 52 move in the liquid crystal cell 14 in a rise. More specifically, (a) of FIG. 5 is a view illustrating directors of second liquid crystal molecules 52b and directors of third liquid crystal molecules 52c which second liquid crystal molecules 52b and third liquid crystal molecules 52c are liquid crystal molecules 52 which are located between two adjacent ones of the rectangular projections 74 in the vicinity of the counter substrate 24.

That is, (a) of FIG. 5 is a view illustrating how the liquid crystal molecules 52 move, in the vicinity of the counter substrate 24, in the first orientational region R1 and the second orientational region R2 in the liquid crystal cell 14 which are illustrated in FIG. 3.

(b) of FIG. 5 is a view illustrating how a first dark line D1 in a fourth vertically-aligned part V4 of the liquid crystal display element 100 of the second comparative example looks.

(a) and (b) of FIG. 6 are views illustrating the liquid crystal display element 10 of the first embodiment, and correspond to (a) and (b) of FIG. 5, respectively.

That is, (a) of FIG. 6 is a view illustrating directors of second liquid crystal molecules 52b and directors of third liquid crystal molecules 52c which second liquid crystal molecules 52b and third liquid crystal molecules 52c are liquid crystal molecules 52 which are located between two adjacent ones of the above-electrode sloping protrusions 74a in the vicinity of the counter substrate 24. (b) of FIG. 6 is a view illustrating how a first dark line D1 in a fourth vertically-aligned part V4 of the liquid crystal display element 10 of the first embodiment looks.

As for the liquid crystal display element 100 of the second comparative example, as illustrated in (b) of FIG. 5, the first dark line D1 is not a straight line but a wavy line. This is because a part of the liquid crystal molecules 52 move first and another part of the liquid crystal molecules 52 move with a delay when the liquid crystal molecules 52 start to move, and accordingly, a time lag is caused between (i) a time point at which movement of the part of the liquid crystal molecules 52 reaches (propagates to) the fourth vertically-aligned part V4 which serves as a disclination line and (ii) a time point at which movement of the another part of the liquid crystal molecules 52 reaches (propagates to) the fourth vertically-aligned part V4.

According to the arrangement of the second comparative example, projections are provided on the counter substrate 22. However, the projections are the rectangular projection 74 having no tapered sections. Accordingly, a part of the liquid crystal molecules 52 move first and another part of the liquid crystal molecules 52 move with a delay, in response in a rise caused when a voltage is applied to the liquid crystal display element 100. In (a) of FIG. 5, liquid crystal molecules 52 indicated by arrows A11 and A14 are liquid crystal molecules 52 which move first, and on the other hand, liquid crystal molecules 52 indicated by arrows A12 and A13 are liquid crystal molecules 52 which move with a delay.

Thus, the liquid crystal molecules 52 indicated by the arrow A11 in (a) of FIG. 5 and the liquid crystal molecules 52 indicated by the arrow A12 in (a) of FIG. 5 reach the fourth vertically-aligned part V4 which serves as a disclination line. This occurs at a position on the first dark like D1 which position is indicated by an arrow A15 in (b) of FIG. 5.

Similarly, the liquid crystal molecules 52 indicated by the arrow A13 and the liquid crystal molecules 52 indicated by the arrow A14 reach the fourth vertically-aligned part V4. This occurs at a position on the first dark like D1 which position is indicated by an arrow A16 in (b) of FIG. 5.

As illustrated in (b) of FIG. 5, a part of the first dark line D1 is observed at a position into which the part of the first dark line D1 is pushed by the liquid crystal molecules 52 which move first, in the vicinity of the disclination line across which the liquid crystal molecules 52 which move first and the liquid crystal molecules 52 which move with a delay face each other.

That is, liquid crystal molecules 52 in the first orientational region R1 and liquid crystal molecules 52 in the second orientational region R2 push against each other in the vicinity of the disclination line. FIG. 7 is a view illustrating orientations of the liquid crystal molecules 52 in the vicinity of the disclination line.

In the vicinity of the fourth vertically-aligned part V4 which serves as a disclination (domain boundary) line, as illustrated in FIG. 7, the liquid crystal molecules 52 in the first orientational region R1 and the liquid crystal molecules 52 in the second orientational region R2 push against each other.

That is, an orientation differs between (i) the second liquid crystal molecules 52b in the first orientational region R1 and the fourth liquid crystal molecules 52d in the second orientational region R2. Therefore, as indicated by arrows in FIG. 7, the second liquid crystal molecules 52b and the fourth liquid crystal molecules 52d push against each other in the vicinity of the disclination line.

In a case where a timing of a start of movement of the liquid crystal molecules 52 is different between the second liquid crystal molecules 52b and the fourth liquid crystal molecules 52d, a director of the second liquid crystal molecules 52b and a director of the fourth liquid crystal molecules 52d vary from each other toward, e.g., a direction extending perpendicularly to an alignment direction of the liquid crystal molecules 52. Accordingly, a boundary across which the second liquid crystal molecules 52b and the fourth liquid crystal molecules 52d push against each other is formed along irregular positions. As a result, the first dark line D1 is likely to be a wavy line.

That is, in a case where the projections are the rectangular projection 74 having no tapered sections, the liquid crystal molecules 52 are likely to have irregular orientations in the vicinity of the projections. Accordingly, the liquid crystal molecules 52 which move first and the liquid crystal molecules 52 which move with a delay are likely to be in irregular positions. As a result, the first dark line D1 is likely to be a wavy line.

### Present Embodiment

In contrast, the projections of the liquid crystal display element 10 of the present embodiment are the sloping protrusions 70 having tapered sections. Accordingly, the liquid crystal molecules 52 are likely to simultaneously move in response in a rise caused when a voltage is applied to the liquid crystal display element 10. In other words, the liquid crystal molecules 52 are unlikely to be divided into (i) the liquid crystal molecules 52 which move first and (ii) the liquid crystal molecules 52 which move with a delay, unlike the liquid crystal display element 100 of the second comparative example.

That is, the liquid crystal molecules 52 simultaneously move in a rise, as indicated by the arrows A1 through A4 in (a) of FIG. 6. Accordingly, a time lag is unlikely to be caused between (i) a time point at which movement of the second liquid crystal molecules 52b in the first orientational region R1 reaches (propagates to) the fourth vertically-aligned part V4 which serves as a disclination line and (ii) a time point at which movement of the fourth liquid crystal molecules 52d in the second orientational region R2 reaches (propagates to) the fourth vertically-aligned part V4.

As a result, the first dark line D1 is likely to be a straight line, as indicated by arrows A5 and A6 in (b) of FIG. 6.

As described above, a dark line of the liquid crystal display element 10 of the present embodiment is less likely to be a wavy line, as compared with a dark line of the liquid crystal display element 100 of the second comparative example. Thus, the liquid crystal display element 10 of the present embodiment has an improved orientational stability.

### First Comparative Example

Since no projection is provided in each of the liquid crystal cells 14 of the liquid crystal display element 100 of the first comparative example, the liquid crystal molecules 52 are likely to be divided, in response in a rise, into those which move first and those which move with a delay, as is the case with the liquid crystal display element 100 of the second comparative example. Accordingly, a dark line of the liquid crystal display element 100 of the first comparative example is likely to be a wavy line, as is the case with the liquid crystal display element 100 of the second comparative example. Thus, the liquid crystal display element 100 of the first comparative example does not have a sufficient orientational stability.

(Response Speed)

The following deals with response speeds. As described above, the liquid crystal display element 10 of the present embodiment has an improved orientational stability, and accordingly has an increased response speed.

As shown in FIG. 4, specifically, the liquid crystal display element 10 of the first embodiment is improved in its response speed by 7.5% in total of a rise and a fall, as compared with the liquid crystal display element 100 of the first comparative example.

Response speed in a rise refers to a response speed when a voltage is applied to the liquid crystal display element 10 so that a voltage is applied to the liquid crystal molecules 52. Similarly, response speed in a fall refers to a response speed at power-off of a liquid crystal display panel. Response speeds shown in FIG. 4 are those for a case where a rectangular wave of ±6.5 V is applied to the liquid crystal cell 14. The response speeds are measured by use of an LCD5200 manufactured by Otsuka Electronics Co., Ltd.

As shown in FIG. 4, a response speed in a rise of the liquid crystal display element 10 of the first embodiment was 4.28 msec. This response speed was a speed improved by 16% from a response speed of 5.11 msec of the liquid crystal display element 100 of the first comparative example.

A response speed in a fall of the liquid crystal display element 10 of the first embodiment was also improved as compared with that of the liquid crystal display element 100 of the first comparative example.

With regard to a total of the response speed in the rise and the response speed in the fall, the liquid crystal display element 10 of the first embodiment was improved by 7.5% as compared with the liquid crystal display element 100 of the first comparative example.

The liquid crystal display element 100 of the second comparative example was not improved in its response speed as compared with the liquid crystal display element 100 of the first comparative example.

The improvement of the response speed of the liquid crystal display element 10 of the first embodiment, particularly, the improvement of the response speed in the rise was achieved because the sloping protrusion 72 each of which has two inclined side surfaces were provided on the counter substrate 22 opposed to the array substrate 22, in respective positions corresponding to centers of the interleaved electrodes 30.

As described with reference to (a) of FIG. 6, due to presence of the sloping protrusions 72, the liquid crystal molecules 52 are less likely to have those which moves with a delay, particularly in a rise. This allows the liquid crystal molecules 52 to simultaneously move more easily. This increases a response seed.

### Second Embodiment

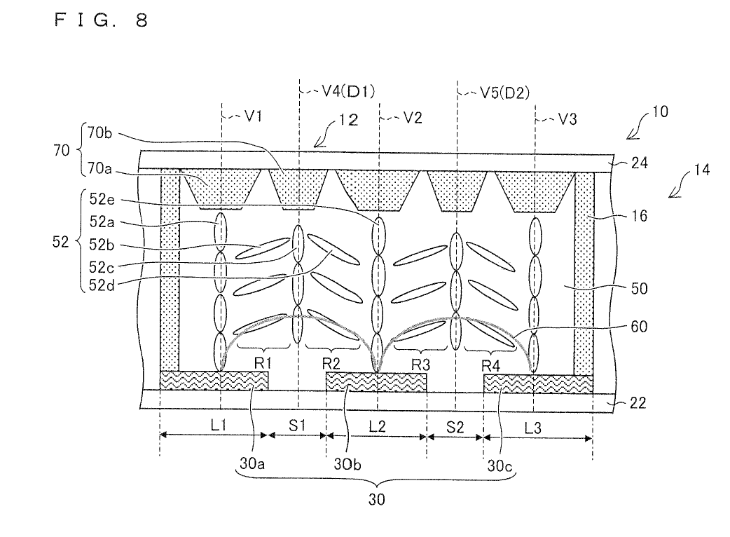

The following describes another embodiment of the liquid crystal display element 10 of the present invention, with reference to FIG. 8 etc. FIG. 8 is a cross-sectional view illustrating a second embodiment of the present invention, specifically, illustrating a schematic arrangement of the liquid crystal display element 10. For convenience, members having the same functions as those of the members in the drawings described in the first embodiment are given identical reference numerals/signs, and descriptions of such members are omitted below.

The liquid crystal display element 10 of the present embodiment is different from the liquid crystal display element 10 of the first embodiment in positions and the number of the sloping protrusions 70. In the liquid crystal display element 10 of the first embodiment, the sloping protrusions 70 are provided as the above-electrode sloping protrusions 70a, only in such positions that the above-electrode sloping protrusions 70a overlap the interleaved electrodes 30 when viewed from above.

In the liquid crystal display element 10 of the present embodiment, in contrast, the sloping protrusions 70 are provided not only in such positions, but also in positions on the counter substrate 24 each of which positions corresponds to a region between two interleaved electrodes 30.

Specifically, above-inter-electrode sloping protrusions 70b are provided as the sloping protrusions 70 also in such positions on the counter substrate 24 that above-inter-electrode sloping protrusions 70b overlap, when viewed from above, (i) a first space range S1 between a first interleaved electrode 30a and a second interleaved electrode 30b, and (ii) a second space range S2 between the second interleaved electrode 30b and a third interleaved electrode 30c.

That is, the sloping protrusions 72 are provided not only above line ranges (first line range L1, second line range L2, and third line range L3) on the array substrate 22, but also above space ranges (first space range S1 and second space range S2) on the array substrate 22 in each of which no line is provided.

As illustrated in FIG. 8, one of the above-inter-electrode sloping protrusions 70b is provided at a position corresponding to a substantial center of a width of the first space range S1. The same holds for the second space range S2.

According to the arrangement, the number of the sloping protrusions 70 to be provided in each of the unit regions 12 is five for the liquid crystal display element 10 of the second embodiment whereas the number of the sloping protrusions 70 to be provided in each of the unit regions 12 is three for the liquid crystal display element 10 of the first embodiment.

As shown FIG. 4, the liquid crystal display element 10 of the second embodiment achieved a high improvement rate not only for the response speed in the rise but also for the response speed in the fall.

That is, the liquid crystal display element 10 of the first embodiment achieved an improvement rate of 1.0% for the response speed in the fall. In contrast, the liquid crystal display element 10 of the second embodiment achieved an improvement rate of 11% for the response speed in the fall.

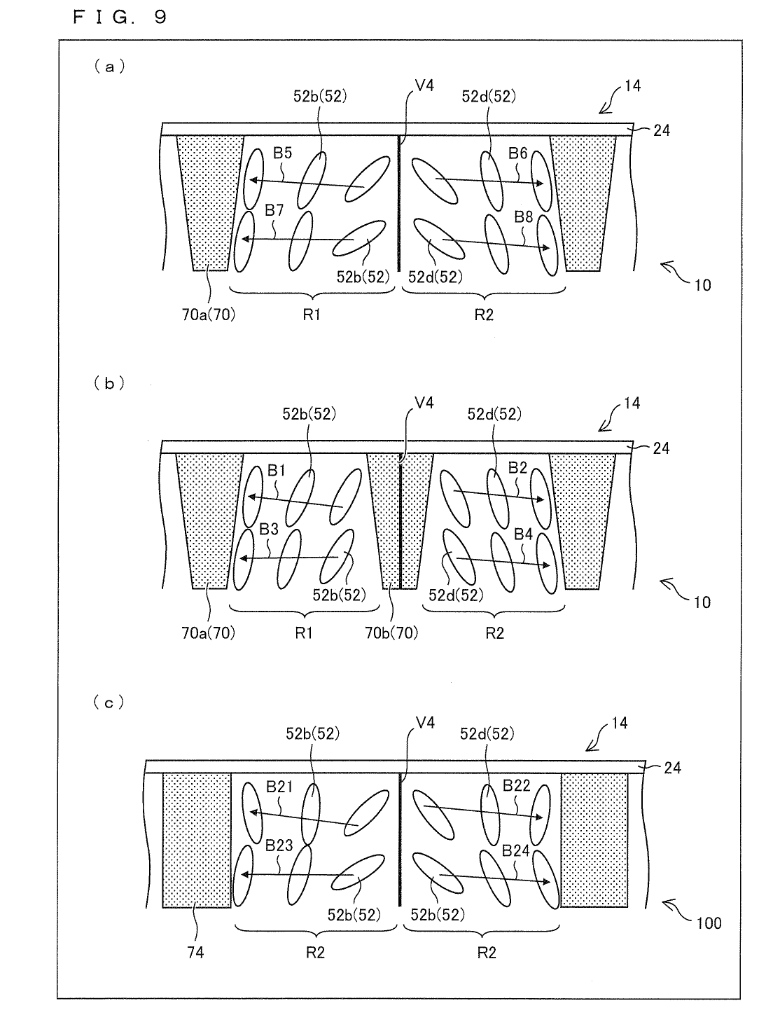

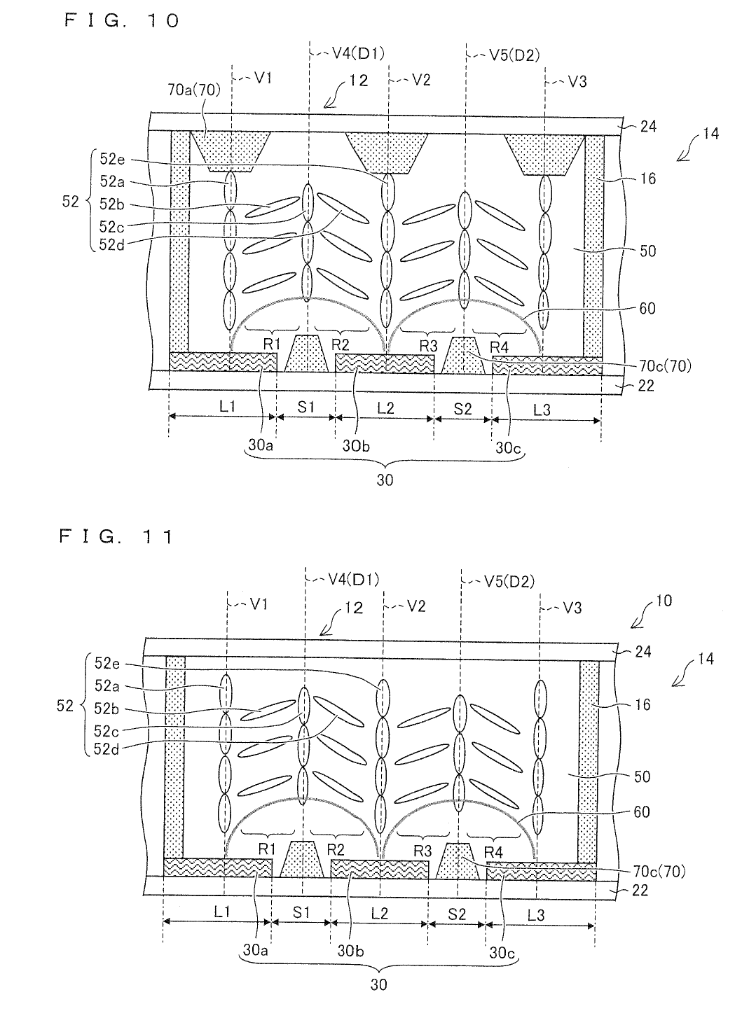

The following describes a relationship between a response speed in a fall and an orientation of the liquid crystal molecules 52, with reference to (a) through (c) of FIG. 9. (a) through (c) of FIG. 9 are views illustrating orientations of the liquid crystal molecules 52. (a) of FIG. 9 corresponds to the first embodiment of the present invention. (b) of FIG. 9 illustrates the first embodiment of the present invention. (c) of FIG. 9 corresponds to the second comparative example.

(Response Speed 1 in Fall)

A response speed in a fall is affected by the above-electrode sloping protrusions 70a and the above-inter-electrode sloping protrusions 70b.

First, the following deals with an effect of the above-electrode sloping protrusions 70a.

A fall of the liquid crystal molecules 52 in the liquid crystal display element 10 of the vertical-alignment transverse-electric-field mode is such movement of the liquid crystal molecules 52 that the liquid crystal molecules 52 return to a vertically-aligned state which is an initial state of the vertical alignment. Specifically, the fall is such movement that the liquid crystal molecules 52 which have been inclined toward the direction parallel to the array substrate 22 and the counter substrate 24 by application of a transverse electric field return to the vertically-aligned state.

A response speed depends on a time between completion of response of the liquid crystal molecules 52 to a halt of voltage supply and stabilization of an aligned state.

In a case where the above-electrode sloping protrusions 70a which are projections each of which has two inclined side surfaces are provided on the counter substrate 24 above the interleaved electrodes 30, liquid crystal molecules 52 in the vicinity of the above-electrode sloping protrusions 70a are likely to have a uniform orientation, as indicated by liquid crystal molecules 52 positioned at heads of arrows B1 through B8 in (a) and (b) of FIG. 9. That is, the liquid crystal molecules 52 are likely to have a uniform orientation at an end of a fall.

In the liquid crystal display element 100 of the second comparative example which has the rectangular projections 74 having no inclined side surfaces, in contrast, the liquid crystal molecules 52 in the vicinity of the rectangular projections 74 are unlikely to have a uniform orientation, as indicated by liquid crystal molecules 52 positioned at heads of arrows B21 through B24 in (c) of FIG. 9.

Therefore, the liquid crystal display element 10 of the first embodiment which has the above-electrode sloping protrusions 70a, and the liquid crystal display element 10 of the second embodiment which has the above-inter-electrode sloping protrusions 70a and the above-electrode sloping protrusions 70b are likely to achieve higher response speeds at falls, as compared with the liquid crystal display element 100 of the second comparative example which has the rectangular projections 74.

(Response Speed 2 in Fall)

A response speed in a fall is affected not only by the above-electrode sloping protrusions 70a provided above the interleaved electrodes 30, but also by the above-inter-electrode sloping protrusions 70b provided above the first and second space ranges S1 and S2. The following describes this.

In each of the liquid crystal display elements 10 of the vertical-alignment transverse-electric-field mode, the liquid crystal molecules 52 have an orientation inclined toward the direction parallel to the array substrate 22 and the counter substrate 24, while a voltage is applied to the liquid crystal display elements 10 before a fall occurs.

In this state, the second liquid crystal molecules 52b in the first orientational region R1 and the fourth liquid crystal molecules 52d in the second orientational region R2 which second liquid crystal molecules 52b and fourth liquid crystal molecules 52d have respective different orientations face each other across the fourth vertically-aligned part V4.

As described with reference to FIG. 7, the second liquid crystal molecules 52b and the fourth liquid crystal molecules 52d push against each other in the vicinity of the fourth vertically-aligned part V4. Accordingly, the liquid crystal molecules 52 are likely to have irregular orientations in the vicinity of the fourth vertically-aligned part V4.

As illustrated in (c) of FIG. 9, as a result, the liquid crystal molecules 52 which have just started, in the fall, to return to their vertically-aligned state are unlikely to move uniformly in the liquid crystal display element 100 of the second comparative example which has no projection corresponding to the fourth vertically-aligned part V4. For example, a liquid crystal molecule 52 positioned at a starting point of the arrow B21 in (c) of FIG. 9 and a liquid crystal molecule 52 positioned at a starting point of the arrow B23 in (c) of FIG. 9 are likely to have respective different orientations. Similarly, a liquid crystal molecule 52 positioned at a starting point of the arrow B22 in (c) of FIG. 9 and a liquid crystal molecule 52 positioned at a starting point of the arrow B24 in (c) of FIG. 9 are likely to have respective different orientations.

As described above, in a case where the liquid crystal molecules 52 have irregular orientations in the vicinity of the fourth vertically-aligned part V4, the liquid crystal molecules 52 which have just started, in the fall, to return to their vertically-aligned state are unlikely to move uniformly.

Accordingly, the liquid crystal molecules 52 are unlikely to have a uniform orientation at the end of the fall, particularly in the vicinity of the above-electrode sloping protrusions 70a.

This indicates that in a case where a fall occurs, it takes a long time to stabilize the orientation of the liquid crystal molecules 52, and furthermore, the liquid crystal molecules 52 are unlikely to end its response movement earlier in the fall.

Thus, it takes a long time from the beginning of the fall to a time point where the orientation of the liquid crystal molecules 52 is stabilized after the fall ends.

The same holds for the liquid crystal display element 10 of the first embodiment illustrated in (b) of FIG. 9. This is because no projection is provided between two adjacent ones of the interleaved electrodes 30, as is the case with the liquid crystal display element 100 of the second comparative example.

### Present Embodiment

As illustrated in (a) of FIG. 9, in contrast, the second liquid crystal molecules 52b and the fourth liquid crystal molecules 52d face the above-inter-electrode sloping protrusion 70b in the liquid crystal display element 10 of the present embodiment which has the above-inter-electrode sloping protrusion 70b at a position corresponding to the fourth vertically-aligned part V4. Accordingly, the liquid crystal molecules 52 are unlikely to have irregular orientations in the vicinity of the fourth vertically-aligned part V4.

In a case where the liquid crystal molecules 52 have an increased uniformity in its orientation in the vicinity of the fourth vertically-aligned part V4, the liquid crystal molecules 52 which have just started, in the fall, to return to their vertically-aligned state are likely to move uniformly.

Accordingly, the liquid crystal molecules 52 are likely to have a uniform orientation in the vertically-aligned state which is the end of the fall, particularly in the vicinity of the above-electrode sloping protrusions 70a. This indicates that it takes a short time in the fall to stabilize the orientation of the liquid crystal molecules 52, and further, the liquid crystal molecules 52 are unlikely to end its response movement earlier in the fall.

As a result, the liquid crystal display element 10 of the second embodiment achieves an increased response speed in a fall.

(Response Speed 3 in Fall)

In a case where the above-inter-electrode sloping protrusion 70b is provided at a position corresponding to the fourth vertically-aligned part V4, the liquid crystal molecules 52 in the vicinity of the fourth vertically-aligned part V4 face the above-inter-electrode sloping protrusion 70b while a voltage is applied before a fall occurs, as illustrated in (a) of FIG. 9. Accordingly, the liquid crystal molecules 52 are unlikely to incline toward the direction parallel to the array substrate 22 and the counter substrate 24.

In each of the liquid crystal display elements 10 and 100 which have no above-inter-electrode sloping protrusion 70b, in contrast, the liquid crystal molecules 52 are likely to have an orientation inclined toward to the direction which is parallel to the array substrate 22 and the counter substrate 24, while a voltage is applied, as illustrated in (c) and (b) of FIG. 9.

As described above, in a case where the above-inter-electrode sloping protrusion 70b is provided at a position corresponding to the fourth vertically-aligned part V4, liquid crystal molecules 52 do not incline too much in the vicinity of the fourth vertically-aligned part V4, as compared with a case where no above-inter-electrode sloping protrusion 70b is provided in the position corresponding to the fourth vertically-aligned part V4.

This allows the liquid crystal molecules 52 to easily return to the vertically-aligned state in a fall. As a result, the liquid crystal display element 10 of the second embodiment achieves an increased response speed in a fall.

(Taper Angle)

The taper angle of the above-inter-electrode sloping protrusions 70b is not particularly limited. A small taper angle, namely, a slight inclining of the above-inter-electrode sloping protrusions 70b makes it possible to obtain the aforementioned effect.

The taper angle (θ) is preferably determined within the range 0°<θ<45° so that the vertical alignment of the liquid crystal molecules 52 which face the above-inter-electrode sloping protrusions 70b is not hindered.

### Third Embodiment

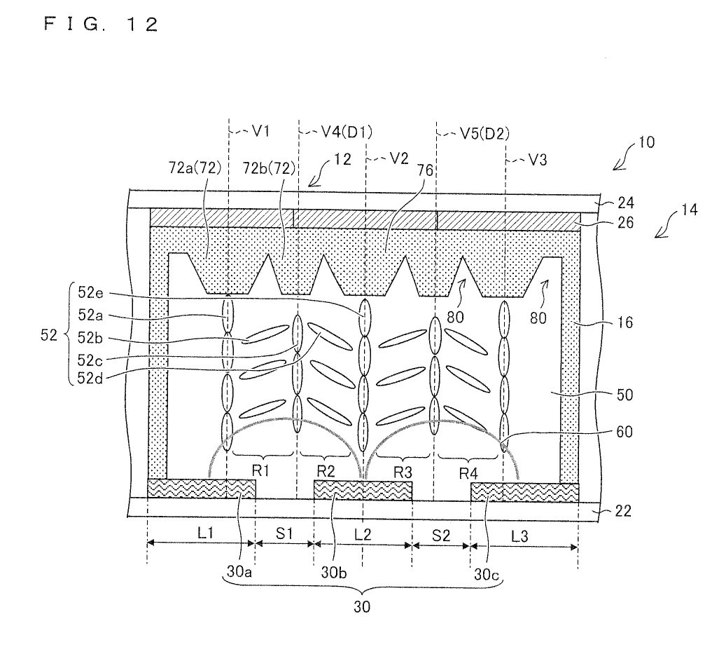

The following describes a third embodiment of the liquid crystal display element 10 of the present invention, with reference to FIG. 10 etc.

For convenience, members having the same functions as those of the members in the drawings described in the first and second embodiments are given identical reference numerals/signs, and descriptions of such members are omitted below.

The liquid crystal display element 10 of the present embodiment is different from the liquid crystal display element 10 of the second embodiment illustrated in FIG. 8 in that sloping protrusions 70 located in space ranges are provided on an array substrate 22.

The following describes this, with reference to FIG. 10 which is a cross-sectional view illustrating a schematic arrangement of the liquid crystal display element 10 of the present embodiment.

As illustrated in FIG. 10, the liquid crystal display element 10 of the present embodiment is arranged such that the sloping protrusions 70 which are located in the space ranges when viewed from above are provided not on a counter substrate but on the array substrate 22. In the case of the liquid crystal display element 10 of the second embodiment, the sloping protrusions 70 located in the space ranges are provided on the counter substrate 24, as the above-inter-electrode sloping protrusions 70b. In the case of the liquid crystal display element 10 of the present embodiment, in contrast, each of the sloping protrusions 70 located in the space ranges is provided, as inter-electrode sloping protrusions 70c, between two adjacent ones of the interleaved electrode 30 on the array substrate 22.

More specifically, the inter-electrode sloping protrusions 70c one of the inter-electrode sloping protrusions 70c is provided between a first interleaved electrode 30a and a second interleaved electrode 30b on the array substrate 22, and another one of the inter-electrode sloping protrusions 70c is provided between the second interleaved electrode 30b and a third interleaved electrode 30c. The one of the inter-electrode sloping protrusions 70c is provided in a substantial center of a width of a first space range S1 between the first interleaved electrode 30a and the second interleaved electrode 30b. Similarly, the another one of the inter-electrode sloping protrusions 70c is provided in a substantial center of a width of a second space range S2 between the second interleaved electrode 30b and the third interleaved electrode 30c.

(Manufacturing Method)

The following describes an overview of a method for manufacturing the liquid crystal display element 10 of the present embodiment.

First, a film of ITO is formed to a thickness of 1400 Å by sputtering on an entire surface of a glass substrate which serves as the array substrate 22. Then, the interleaved electrodes 30 made from ITO each of which has an electrode width of 4.0 μm and an electrode interval of 4.0 μm are formed from the film of ITO by photolithography.

Then, an acrylic photosensitive photospacer (columnar spacer) material manufactured by JSR Corp. is applied by spin coating onto an entire surface of the glass substrate. Then, each of the sloping protrusions 70 having a taper angle of 15° and a height of 0.5 μm is formed by photolithography, as an inter-electrode sloping protrusion 70c, in a center between two adjacent ones of the interleaved electrodes 30 (in a center between two adjacent lines), namely, in a center of a corresponding one of the space ranges.

Then, an alignment-film coating material manufactured by JSR Corp. (product name: JALS-204 (5 wt. %, gamma-butyrolactone solution)) is applied onto the glass substrate by spin coating, and then baked for 2 hours at 200° C.

Then, the acrylic photosensitive photospacer (columnar spacer) material manufactured by JSR Corp. is applied by spin coating onto an entire surface of the glass substrate which serves as the counter substrate 24 which is opposed to the array substrate 22. Then, the above-electrode sloping protrusions 70a (height 0.5 μm and taper angle 15°) and the columnar spacers 16 (height 3.4 μm) for controlling cell thickness are simultaneously formed by photolithography.

In this process, a mesh size of a photomask is changed between columnar parts (columnar spacers 16) and projection parts (above-electrode sloping protrusions 70a) so that an exposure amount is controlled. This makes it possible to separately form the columnar spacers 16 and the above-electrode sloping protrusions 70a.

Then, the alignment-film coating material manufactured by JSR Corp. (product name: JALS-204 (5 wt. %, gamma-butyrolactone solution)) is applied onto the array substrate 22 and the counter substrate 24 by spin coating, and then baked for 2 hours at 200° C. Each of an alignment film on the array substrate 22 and an alignment film on the counter substrate 24 has a thickness of 1000 Å.

Then, a sealing resin manufactured by Mitsui Toatsu Chemicals, Inc. (product name: STRUCTBOND XN-21S) is printed on at least one of the array substrate 22 and the counter substrate 24, and then, the array substrate 22 and the counter substrate 24 are attached to each other. Then, the array substrate 22 and the counter substrate 24 thus attached to each other are baked for 1 hour at 135° C. Thus, the liquid crystal cells 14 are fabricated.

Then, a positive type liquid crystal material (Δ∈=22, Δn=0.1) manufactured by Merck Ltd. is injected into the liquid crystal cells 14 by a liquid crystal filling vacuum injection method. Then, a polarization plate is attached to the liquid crystal cells 14 so that the liquid crystal display element 10 is fabricated.

(Characteristics)

The following describes characteristics of the liquid crystal display element 10 of the present embodiment, with reference to FIG. 4.

As shown in FIG. 4, the liquid crystal display element 10 of the present embodiment achieved an orientational stability and a response speed which are close to those of the liquid crystal display element 10 of the second embodiment.

That is, the orientational stability was good and improvement rates of response speeds in a rise and a fall were also close to those of the liquid crystal display element 10 of the second embodiment.

### Fourth Embodiment

The following describes a fourth embodiment of the liquid crystal display element 10 of the present invention, with reference to FIG. 11 etc.

For convenience, members having the same functions as those of the members in the drawings described in the first through third embodiments are given identical reference numerals/signs, and descriptions of such members are omitted below.

The liquid crystal display element 10 of the present embodiment is different from the liquid crystal display element 10 of the third embodiment which is illustrated in FIG. 10 in that no sloping protrusion 70 is provided on the counter substrate 24.

The following describes this, with reference to FIG. 11 which is a cross-sectional view illustrating a schematic arrangement of the liquid crystal display element 10 of the present embodiment.

The liquid crystal display element 10 of the present embodiment is arranged such that when viewed from above, sloping protrusions 70 are provided only in space ranges, i.e., no sloping protrusion 70 is provided in each of line ranges. The sloping protrusions 70 located in the space ranges are provided on the array substrate 22, as inter-electrode sloping protrusions 70c.

Positions, a shape, etc. of the inter-electrode sloping protrusions 70c provided on the array substrate 22 are the same as those of the third embodiment.

(Manufacturing Method)

The following describes an overview of a method for manufacturing the liquid crystal display element 10 of the present embodiment.

First, a film of ITO is formed to a thickness of 1400 Å by sputtering on an entire surface of a glass substrate which serves as the array substrate 22. Then, the interleaved electrodes 30 made from ITO each of which has an electrode width of 4.0 μM and an electrode interval of 4.0 μm are formed from the film of ITO by photolithography.

Then, an acrylic photosensitive photospacer (columnar spacer) material manufactured by JSR Corp. is applied by spin coating onto an entire surface of the glass substrate. Then, each of protrusions (height 0.5 μm, taper angle 15°) is formed by photolithography in a center between two adjacent lines.

Then, an alignment-film coating material manufactured by JSR Corp. (product name: JALS-204 (5 wt. %, gamma-butyrolactone solution)) is applied onto the glass substrate by spin coating, and then baked for 2 hours at 200° C.

Then, an acrylic photosensitive photospacer (columnar spacer) material manufactured by JSR Corp. is applied by spin coating onto an entire surface of the glass substrate which serves as the counter substrate 24. Then, columnar spacers 16 having a height of 3.4 um for controlling cell thickness are formed by photolithography.

Then, the alignment-film coating material manufactured by JSR Corp. (product name: JALS-204 (5 wt. %, gamma-butyrolactone solution)) is applied onto the array substrate 22 and the counter substrate 24 by spin coating, and then baked for 2 hours at 200° C. Each of an alignment film on the array substrate 22 and an alignment film on the counter substrate 24 has a thickness of 1000 Å.

Then, a sealing resin manufactured by Mitsui Toatsu Chemicals, Inc. (product name: STRUCTBOND XN-21S) is printed on at least one of the array substrate 22 and the counter substrate 24, and then, the array substrate 22 and the counter substrate 24 are attached to each other. Then, the array substrate 22 and the counter substrate 24 thus attached to each other are baked for 1 hour at 135° C. Thus, the liquid crystal cells 14 are fabricated.

Then, a positive type liquid crystal material (Δ∈=22, Δn=0.1) manufactured by Merck Ltd. is injected into the liquid crystal cells 14 by a liquid crystal filling vacuum injection method. Then, a polarization plate is attached to the liquid crystal cells 14 so that the liquid crystal display element 10 is fabricated.

(Characteristics)

The following describes characteristics of the liquid crystal display element 10 of the present embodiment, with reference to FIG. 4.

As shown in FIG. 4, the liquid crystal display element 10 of the present embodiment achieved a good orientational stability. The liquid crystal display element 10 also achieved improved response speeds in a rise and a fall, as compared with the liquid crystal display element 100 of the first comparative example.

The liquid crystal display element 10 of the present embodiment has such a simple arrangement that no projection is provided in each of the line ranges but the projections are provided in the space ranges. This makes it possible to improve response speeds etc.

### Fifth Embodiment

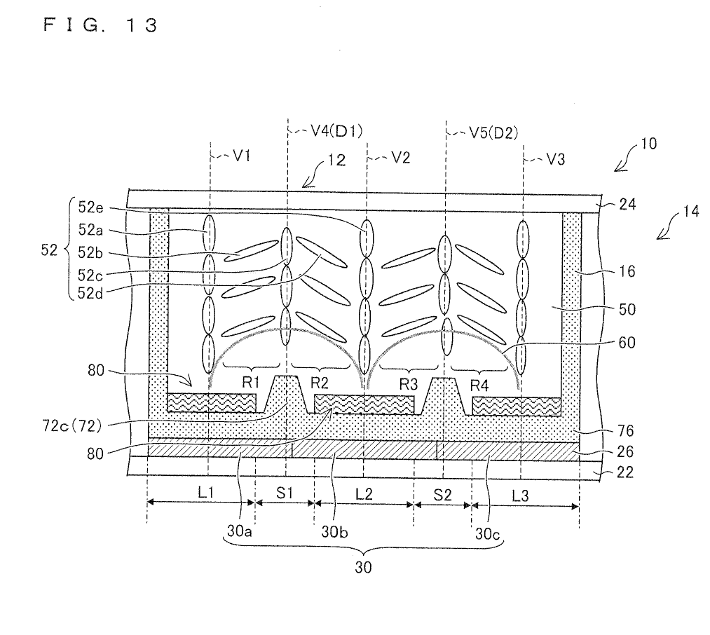

The following describes a fifth embodiment of the liquid crystal display element 10 of the present invention, with reference to FIG. 12 etc.

For convenience, members having the same functions as those of the members in the drawings described in the first through fourth embodiments are given identical reference numerals/signs, and descriptions of such members are omitted below.

The liquid crystal display element 10 of the present embodiment is different from the liquid crystal display element 10 of the second embodiment which is illustrated in FIG. 8 in that sloping protrusions 72 provided on a counter substrate 24 are not made from a material for columnar spacers 16, but are formed by processing a planarizing layer on color filters.

The following describes this, with reference to FIG. 12 which is a cross-sectional view illustrating a schematic arrangement of the liquid crystal display element 10 of the present embodiment.

The liquid crystal display element 10 of the present embodiment is arranged such that sloping protrusions 72 formed from the planarizing layer are provided in the same positions as those of the sloping protrusions 70 of the liquid crystal display element 10 of the second embodiment which is illustrated in FIG. 8.

That is, each of the sloping protrusions 72 is provided on the counter substrate 24 at a position corresponding to a substantial center of a width of any one of line ranges (first line range L1, second line range L2, and third line range L3) or at a position corresponding to a substantial center of a width of any one of space ranges (first space range S1 and second space range S2). The following describes this in more detail.

The liquid crystal display element 10 of the present embodiment is arranged such that color filters 26 are provided on a surface of the counter substrate 24 which surface faces a liquid crystal layer 50.

A planarizing layer 76 which serves as an overcoating layer is provided as an upper layer on the color filters 26, namely, provided on a surface of the color filters 26 which surface faces the liquid crystal layer 50. The planarizing layer 76 has planarizing layer hollowed sections 80 which are parts hollowed in a slit-like shape.

As a result of formation of the planarizing layer hollowed sections 80 in the planarizing layer 76, the liquid crystal display element 10 of the present embodiment has the sloping protrusions which have substantially the same shape as the sloping protrusions 70 in FIG. 8 which are made from the material from which the columnar spacers 16 are made.

In other words, above-electrode sloping protrusions 72a and above-inter-electrode sloping protrusions 72b which are the sloping protrusions 72 of the present embodiment are substantially the same in their trapezoidal shape, their height, their taper angle, etc. as the above-electrode sloping protrusions 70a and the above-inter-electrode sloping protrusions 70b, which are made from the material from which the columnar spacers 16 are made.

(Manufacturing Method)

The following describes an overview of a method for manufacturing the liquid crystal display element 10 of the present embodiment.

First, a film of ITO is formed to a thickness of 1400 Å by sputtering on an entire surface of a glass substrate which serves as the array substrate 22. Then, the interleaved electrodes 30 made from ITO each of which has an electrode width of 4.0 μm and an electrode interval of 4.0 μm are formed from the film of ITO by photolithography.

Then, an alignment-film coating material manufactured by JSR Corp. (product name: JALS-204 (5 wt. %, gamma-butyrolactone solution)) is applied onto the glass substrate by spin coating, and then baked for 2 hours at 200° C.

Further, the color filters (CF) are formed on a glass substrate which serves as the counter substrate 24. Then, an acrylic photosensitive photospacer (columnar spacer) material manufactured by JSR Corp. is applied, as the planarizing layer (overcoating layer), by spin coating onto an entire surface of the glass substrate. Then, slits (height 0.5 μm, taper angle 15°) which serve as the planarizing layer hollowed sections 80 are formed by photolithography so that the sloping protrusions 72 have a desired shape.

Further, columnar spacers 16 having a height of 3.4 μm for controlling cell thickness are formed simultaneously with formation of the slits.

In forming the planarizing layer hollowed sections 80 and the columnar spacers 16, a layer for protecting the color filters is left so as to have a thickness of 1.5 μm.

Further, a mesh size of a photomask which is used in forming the planarizing layer hollowed sections 80 etc. by photolithography is changed between columnar parts and projection parts so that an exposure amount is controlled.

Then, the alignment-film coating material manufactured by JSR Corp. (product name: JALS-204 (5 wt. %, gamma-butyrolactone solution)) is applied onto the array substrate 22 and the counter substrate 24 by spin coating, and then baked for 2 hours at 200° C. Each of an alignment film on the array substrate 22 and an alignment film on the counter substrate 24 has a thickness of 1000 Å.

Then, a sealing resin manufactured by Mitsui Toatsu Chemicals, Inc. (product name: STRUCTBOND XN-21S) is printed on at least one of the array substrate 22 and the counter substrate 24, and then, the array substrate 22 and the counter substrate 24 are attached to each other. Then, the array substrate 22 and the counter substrate 24 thus attached to each other are baked for 1 hour at 135° C. Thus, the liquid crystal cells 14 are fabricated.

Then, a positive type liquid crystal material (Δ∈=22, Δn=0.1) manufactured by Merck Ltd. is injected into the liquid crystal cells 14 by a liquid crystal filling vacuum injection method. Then, a polarization plate is attached to the liquid crystal cells 14 so that the liquid crystal display element 10 is fabricated.

(Characteristics)

The following describes characteristics of the liquid crystal display element 10 of the present embodiment, with reference to FIG. 4.

As shown in FIG. 4, the liquid crystal display element 10 of the present embodiment achieved a good orientational stability. As for its response speeds, the liquid crystal display element 10 also achieved improvements for a rise and a fall which improvements are substantially equivalent to those of the liquid crystal display element 10 of the second embodiment.

According to the arrangement above, the sloping protrusions 72 and the columnar spacers 16 are formed from the planarizing layer provided on the color filters. Therefore, there is no need to add a process for forming the sloping protrusions 72.

### Sixth Embodiment

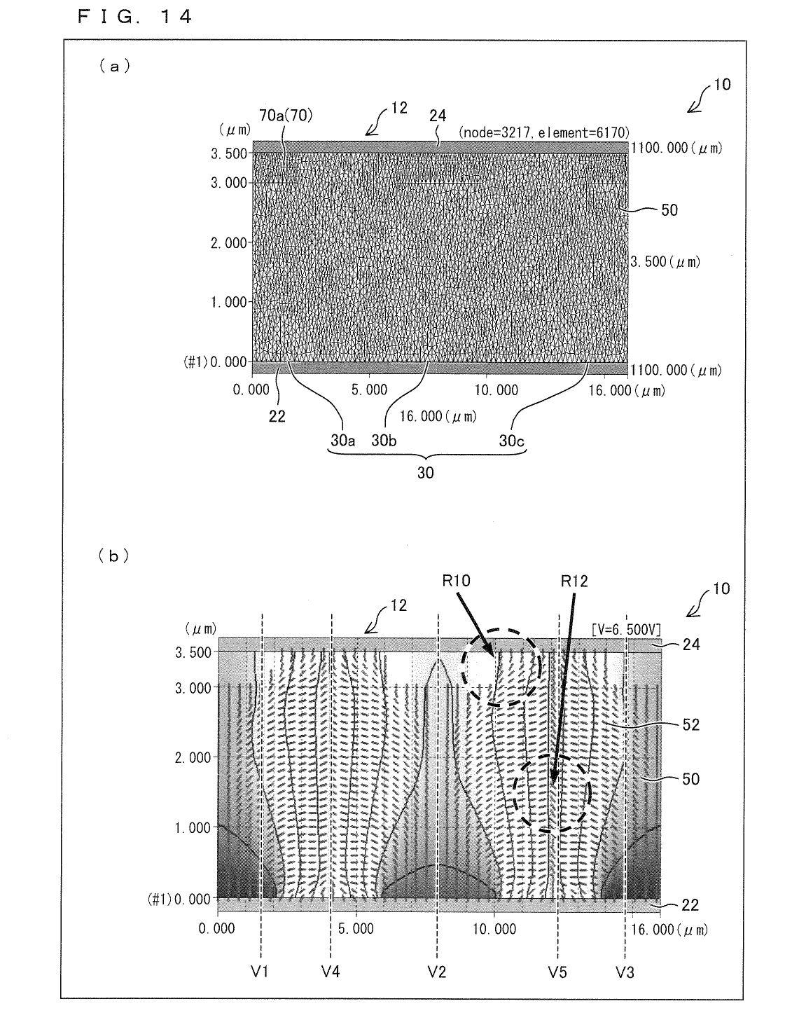

The following describes a sixth embodiment of the liquid crystal display element 10 of the present invention, with reference to FIG. 13 etc.

For convenience, members having the same functions as those of the members in the drawings described in the first through fifth embodiments are given identical reference numerals/signs, and descriptions of such members are omitted below.

The liquid crystal display element 10 of the present embodiment is different from the liquid crystal display element 10 of the fourth embodiment which is illustrated in FIG. 11 in that sloping protrusions 72 provided on an array substrate 22 are not made from a material for columnar spacers 16, but are formed by processing a planarizing layer provided on color filters.

The arrangement is common between the liquid crystal display element 10 of the present embodiment and the liquid crystal display element 10 of the fifth embodiment which is illustrated in FIG. 12.

The following describes this, with reference to FIG. 13 which is a cross-sectional view illustrating a schematic arrangement of the liquid crystal display element 10 of the present embodiment.

The liquid crystal display element 10 of the present embodiment is arranged such that sloping protrusions 72 formed from the planarizing layer are provided in the same positions as those of the sloping protrusions 70 of the liquid crystal display element 10 of the fourth embodiment which is illustrated in FIG. 11.

That is, each of the sloping protrusions 72 is provided on the array substrate 22 at a position corresponding to a substantial center of a width of any one of space ranges (first space range S1 and second space range S2). The following describes this in more detail.

The liquid crystal display element 10 of the present embodiment is arranged such that color filters 26 are provided on a surface of the array substrate 22 which surface faces a liquid crystal layer 50.

A planarizing layer 76 which serves as an overcoating layer is provided as an upper layer on the color filters 26. The planarizing layer 76 has planarizing layer hollowed sections 80 which are parts hollowed in a slit-like shape.

As a result of formation of the planarizing layer hollowed sections 80 in the planarizing layer 76, the liquid crystal display element 10 of the present embodiment has the sloping protrusions which have substantially the same shape as the sloping protrusions 70 in FIG. 11 which are made from the material from which the columnar spacers 16 are made.

In other words, inter-electrode sloping protrusions 72c which are the sloping protrusions 72 of the present embodiment are substantially the same in their trapezoidal shape, their height, their taper angle, etc. as the inter-electrode sloping protrusions 70c made from the material from which the columnar spacers 16 are made.

The liquid crystal display element 10 of the present embodiment is arranged such that the interleaved electrodes 30 are provided on the planarizing layer 76. Specifically, each of the interleaved electrodes 30 is provided on the planarizing layer 76, between one of the columnar spacers 16 and an adjacent inter-electrode sloping protrusion 72c, or between two adjacent ones of the inter-electrode sloping protrusions 72c.

(Manufacturing Method)

The following describes an overview of a method for manufacturing the liquid crystal display element 10 of the present embodiment.

First, the color filters 26 are formed on a glass substrate which serves as the array substrate 22. Then, an acrylic photosensitive photospacer (columnar spacer) material manufactured by JSR Corp. is applied by spin coating onto an entire surface of the glass substrate so that the planarizing layer 76 is formed.

Then, the planarizing layer 76 is processed by photolithography. Specifically, slits which serves as planarizing layer hollowed sections 80 are formed by photolithography so as to have a height of 0.5 μm and a taper angle of 15°, so that the planarizing layer 76 is left so as to have a film thickness of 1.5 μm in order that the color filters 26 are protected. Further, columnar spacers 16 having a height of 3.4 μm for controlling cell thickness are formed simultaneously with formation of the slits.

Further, a mesh size of a photomask which is used in processing the planarizing layer 76 is changed between columnar parts (parts where the columnar spacers 16 are formed) and projection parts (parts where the sloping protrusions 72 are formed) so that an exposure amount is controlled.

Then, a film of ITO is formed by sputtering to a thickness of 1400 Å on an entire surface of the planarizing layer 76. Then, the interleaved electrodes 30 made from ITO each of which has an electrode width of 4.0 μm and an electrode interval of 4.0 μm are formed from the film of ITO by photolithography.

Further, an alignment-film coating material manufactured by JSR Corp. (product name: JALS-204 (5 wt. %, gamma-butyrolactone solution)) is applied onto the glass substrate by spin coating, and then baked for 2 hours at 200° C.

Then, the alignment-film coating material manufactured by JSR Corp. (product name: JALS-204 (5 wt. %, gamma-butyrolactone solution)) is applied by spin coating onto a glass substrate which serves as the counter substrate 24 which is opposed to the array substrate 22, and then baked for 2 hours at 200° C.

Each of an alignment film on the array substrate 22 and an alignment film on the counter substrate 24 has a thickness of 1000 Å

Then, a sealing resin manufactured by Mitsui Toatsu Chemicals, Inc. (product name: STRUCTBOND XN-21S) is printed on at least one of the array substrate 22 and the counter substrate 24, and then, the array substrate 22 and the counter substrate 24 are attached to each other. Then, the array substrate 22 and the counter substrate 24 thus attached to each other are baked for 1 hour at 135° C. Thus, the liquid crystal cells 14 are fabricated.

Then, a positive type liquid crystal material (Δ∈=22, Δn=0.1) manufactured by Merck Ltd. is injected into the liquid crystal cells 14 by a liquid crystal filling vacuum injection method. Then, a polarization plate is attached to the liquid crystal cells 14 so that the liquid crystal display element 10 is fabricated.

(Characteristics)

The following describes characteristics of the liquid crystal display element 10 of the present embodiment, with reference to FIG. 4.

As shown in FIG. 4, the liquid crystal display element 10 of the present embodiment achieved a good orientational stability. As for its response speeds, the liquid crystal display element 10 also achieved improvements for a rise and a fall which improvements are substantially equivalent to those of the liquid crystal display element 10 of the fourth embodiment.

(Summary of Response Speeds)

As described above, it is possible to exemplify, as arrangements effective particularly for improvement of a response speed in a rise, such arrangements of the first through third and fourth embodiments that the sloping protrusions are provided in the line ranges.

On the other hand, it is possible to exemplify, as arrangements effective particularly for improvement of a response speed in a fall, such arrangements of the second through sixth embodiments that the sloping protrusions are provided in the space ranges. Among them, such arrangements that the sloping protrusions are provided in the space ranges and in the line ranges achieved greater improvements in response speeds in the falls. Although a substrate on which the sloping protrusions are provided in the line ranges is limited to the counter substrate, it was possible to obtain similar effects both in a case where the sloping protrusions are provided on the array substrate in the space ranges and in a case where the sloping protrusions are provided on the counter substrate in the space ranges.

(Display Unevenness)

The liquid crystal display elements 10 of the first through third and fifth embodiments in each of which liquid crystal display elements 10 the sloping protrusions are provided in the line ranges make it possible to produce an effect of suppressing an occurrence of display unevenness which occurs when a pressing force is applied to the liquid crystal display elements 10, in addition to the effect of increasing response speeds.

That is, in a case where one of the liquid crystal display element 10 is pressed by a finger or the like so that a thickness of the liquid crystal layer 50 is decreased, an orientation of the liquid crystal molecules 52 changes accordingly. This causes a change in transmittance. As a result, display unevenness occurs.

As described above, the liquid crystal display elements 10 of the first through third and fifth embodiments are arranged such that the sloping protrusions are provided in the line ranges. Accordingly, a thickness of the liquid crystal layer 50 in the line ranges is smaller than a thickness of the liquid crystal layer 50 in the space ranges.

Therefore, even if a pressing force is applied to the liquid crystal display element 10 so that the orientation of the liquid crystal molecules 52 is changed, a retardation of the liquid crystal layer 50 in the space ranges which affect display is unlikely to change. In a case where the thickness of the liquid crystal layer 50 in the line ranges is smaller than the thickness of the liquid crystal layer 50 in the space ranges, and no pressing force is applied to the liquid crystal display element 10, the liquid crystal layer 50 in the space ranges serves as a nonresponsive part so as not to affect display significantly. This is because the nonresponsive part is a part where an electric field intensity is weak, and accordingly, the liquid crystal molecules 52 are unlikely to be inclined.

In a case where a pressing force is applied to the liquid crystal display element 10 so that the nonresponsive part is distorted, the liquid crystal molecules 52 in the nonresponsive part are likely to be inclined. As a result, a retardation in the space ranges is likely to be maintained at an optimum value.

Thus, the liquid crystal display elements 10 of the first through third and fifth embodiments make it possible to suppress an occurrence of display unevenness which is caused when a pressing force is applied to each of the liquid crystal display elements 10.

(Simulation)

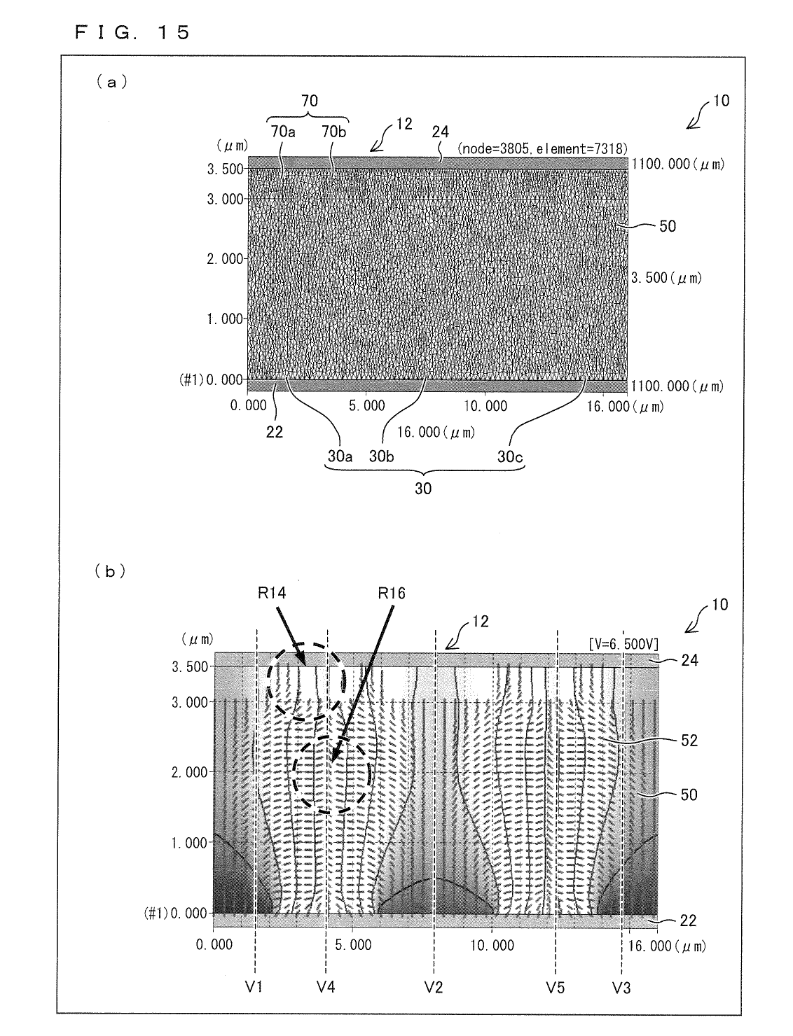

With reference to FIGS. 14 through 18, the following describes orientations (directors) of the liquid crystal molecules 52, for a case where the sloping protrusions 7072 are provided and a case where the sloping protrusions 7072 are not provided. That is, the following describes stabilization of the directors (orientations) which stabilization depends on the presence or absence of the sloping protrusions 7072.

Evaluation results of the directors of the liquid crystal molecules 52 were obtained by carrying out simulations. The simulations were carried out by use of an LCD-MASTER manufactured by SHINTECH, Inc.

FIGS. 14 through 18 show results of the simulations, and schematic structures of the liquid crystal display elements which schematic structures were employed in the simulations.

Specifically, (a) of FIGS. 14 through 18 show schematic arrangements of the liquid crystal display elements which schematic arrangements were employed in the simulations. (b) of FIGS. 14 through 18 show simulated orientations of the liquid crystal molecules.

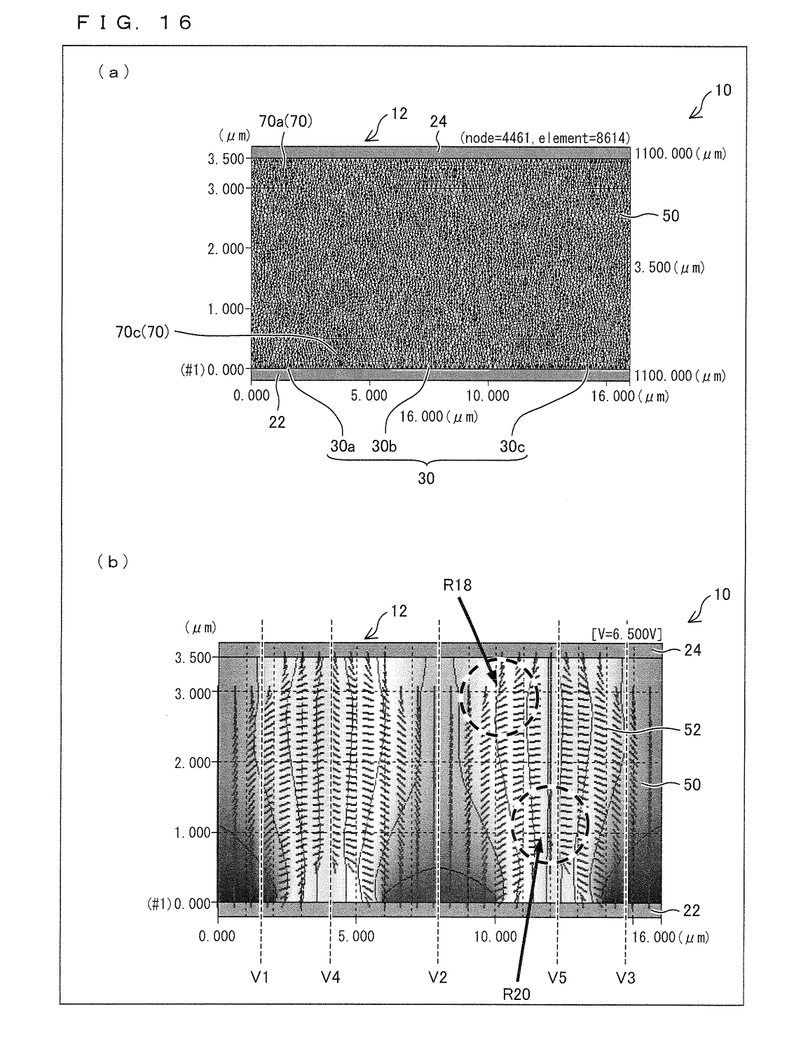

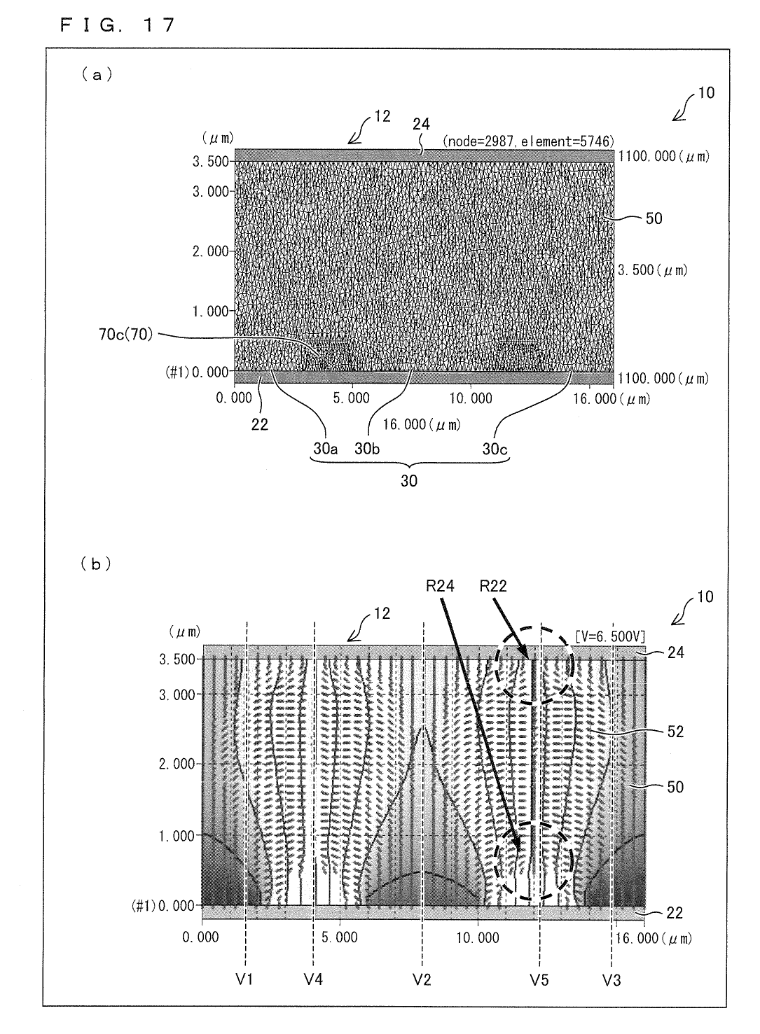

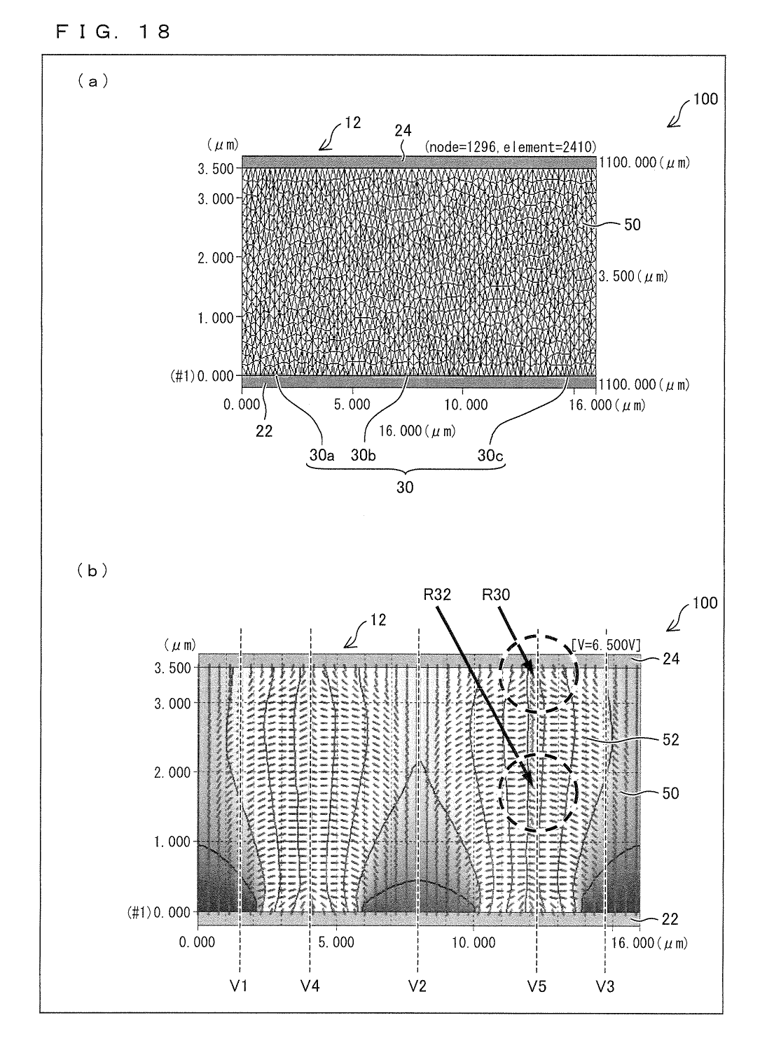

FIG. 14 corresponds to the liquid crystal display element 10 of the first embodiment of the present invention. FIG. 15 corresponds to the liquid crystal display elements 10 of the second and fifth embodiments of the present invention. FIG. 16 corresponds to the liquid crystal display elements 10 of the third embodiment of the present invention. FIG. 17 corresponds to the liquid crystal display elements 10 of the fourth and sixth embodiments of the present invention. FIG. 18 corresponds to the liquid crystal display elements 100 of the first comparative example.

A indicated in regions R30 and R32 in (b) of FIG. 18, the liquid crystal molecules 52 in the liquid crystal display element 100 of the first comparative example had unstable orientations in the vertically-aligned part since the liquid crystal display element 100 has no sloping protrusion.

As illustrated in (b) of FIG. 14, in contrast, the liquid crystal display element of the first embodiment has the above-electrode sloping protrusions 70a in the line ranges. Accordingly, the liquid crystal molecules 52 in the vicinity of the above-electrode sloping protrusions 70a had stable orientations, as indicated in a region R10.

Each of the liquid crystal display elements 10 of the second and fifth embodiments has the above-electrode sloping protrusions 70a and the above-inter-electrode sloping protrusions 70b. As indicated in regions R14 and R16 in (b) of FIG. 15, as a result, the liquid crystal molecules 52 had stable orientations in the vertically-aligned parts in the space ranges although in liquid crystal display element 10 of the first embodiment, the liquid crystal molecules 52 had somewhat unstable orientations (region R12 in (b) of FIG. 14) in the vertically-aligned parts in the space ranges.

Also in a case where the sloping protrusions in the space ranges are provided not on the counter substrate 24 but on the array substrate 22 as is the case with the liquid crystal display element 10 of the third embodiment which is illustrated in (b) of FIG. 16, the liquid crystal molecules 52 had stable orientations as indicated in regions R18 and R20 in (b) of FIG. 16, as is the case with the liquid crystal display elements 10 of the second and fifth embodiments.

Also in a case where sloping protrusions are provided only in the space ranges as is the case with the liquid crystal display elements 10 of the fourth and sixth embodiments illustrated in (b) of FIG. 17, the liquid crystal molecules 52 had stable orientations as indicated in regions R22 and R24 in (b) of FIG. 17.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

Further, a liquid crystal display element of the present invention is arranged such that interleaved electrodes are provided on at least a first substrate; and each of said projections is provided at a position which (i) is on a surface of a second substrate which surface faces the liquid crystal layer, and (ii) overlaps corresponding one of the interleaved electrodes on the first substrate when viewed from above, where either one of the substrates on which the interleaved electrodes are formed is referred to as the first substrate and the other one of the substrates which faces the first substrate is referred to as the second substrate.

According to the arrangement, the projections each of which has a taper shape are provided in respective positions where the projections overlap the electrodes. Each of the electrodes corresponds to a starting point or an ending point of a generated transverse electric field. Accordingly, the liquid crystal molecules start to move at a same timing, particularly in a rise which is a movement of the liquid crystal molecules which movement starts from the vicinity of two adjacent electrodes with respect to a symmetric axis which is a center of the generated transverse electric field. This increases a response speed.

Further, directors of the liquid crystal molecules are likely to be uniform after the rise ends. As a result, a dark line to be observed between two adjacent electrodes is unlikely to be a wavy line.

Further, a liquid crystal display element of the present invention is arranged such that interleaved electrodes are provided on at least the first substrate; and each of said projections is provided at a position which (i) is on a surface of at least one of the first substrate and the second substrate which surface faces the liquid crystal layer, and (ii) is a position between two adjacent ones of the interleaved electrodes when viewed from above.

According to the arrangement, each of the projections is provided at a position between two adjacent ones of the electrodes.

Accordingly, the liquid crystal molecules are not inclined too much at a position corresponding to a position between two adjacent ones of the electrodes, namely, in the vicinity of the center line of the transverse electric field. This increases a response speed particularly in a fall.

Further, a liquid crystal display element of the present invention further includes: color filters; and a planarizing layer which covers said color filters, said color filters and said planarizing layer being provided, in this order toward the liquid crystal layer, on at least one of the first substrate and the second substrate, said projections being formed from said planarizing layer.

The arrangement makes it possible to easily provide the projections, without adding another process or another layer, since the projections are formed from the planarizing layer.

Further, the liquid crystal display element of the present invention is arranged such that an angle formed between (i) a direction perpendicular to at least one of the first substrate and the second substrate on which said projections are provided, and (ii) each of directions in which two inclined surfaces of each of said projections extend is not smaller than 0° but not greater than 50°.

Further, the liquid crystal display element of the present invention is arranged such that the angle is not smaller than 6° but not greater than 25°.

According to the arrangement, an angle (≦90°) formed between (i) the direction perpendicular to a substrate, and (ii) each of directions in which two inclined surfaces of each of the projections extend is not greater than 50°. Therefore, vertically-aligned liquid crystal molecules in the vicinity of the projections are unlikely to have irregular orientations.

Further, in a case where the angle is not smaller than 6° but not greater than 25°, a light leakage toward a front direction of the liquid crystal display element is suppressed. This makes it easy to secure a high contrast of, e.g., not lower than 80%.

Further, the liquid crystal display element of the present invention is arranged such that each of said projections has a height of not smaller than 0.5 μm but not greater than 50% of a thickness of the liquid crystal layer.

According to the arrangement, each of the projections has a height of not smaller than 0.5 μm but not greater than 50% of a thickness of the liquid crystal layer. This brings about ease in manufacturing, and prevents irregular orientations of the liquid crystal molecule in the vicinity of the projections.

Further, the liquid crystal display element of the present invention is arranged such that two straight lines extended from two inclined surfaces of each of said projections intersect with each other on a corresponding one of the boundaries of the orientational regions.

According to the arrangement, the two straight lines extended from the two inclined surfaces of each of the projections intersect with each other on a corresponding one of the boundaries of the orientational regions. Accordingly, the taper shape of each of the projections is likely to be a symmetrical shape with respect to a symmetrical axis which is a boundary of two adjacent orientational regions. This makes it possible to suppress irregularity in orientation of the liquid crystal molecules in the vicinity of the protrusions which irregularity is caused by the provision of the protrusions.

Further, the liquid crystal display element of the present invention is arranged such that each of said projections has a trapezoidal cross-sectional shape.

Further, the liquid crystal display element of the present invention is arranged such that each of the orientational regions is a region sandwiched between two adjacent vertically-aligned parts.

Further, a liquid crystal display device of the present invention includes, as a display section, any one of the liquid crystal display elements.

### INDUSTRIAL APPLICABILITY

The liquid crystal display element of the present invention achieves improved response speed and improved orientation stability. Therefore, the liquid crystal display element is suitably applicable to a liquid crystal display device etc. which are required to perform high-quality display.

### REFERENCE SIGNS LIST

10 Liquid crystal display element
22 Array substrate (substrate)
24 Counter substrate (substrate)
26 Color filter
30 Interleaved electrode (electrode having a shape like a comb tooth)
30a First interleaved electrode (electrode having a shape like a comb tooth)
30b second interleaved electrode (electrode having a shape like a comb tooth)
30c Third interleaved electrode (electrode having a shape like a comb tooth)
50 Liquid crystal layer
52 Liquid crystal molecule
60 Electric field
70 Sloping protrusion (projection)
70a Above-electrode sloping protrusion (projection)
70b Above-inter-electrode sloping protrusion (projection)
70c Inter-electrode sloping protrusion (projection)
72 Sloping protrusion (projection)
72a Above-electrode sloping protrusion (projection)
72b Above-inter-electrode sloping protrusion (projection)
72c Inter-electrode sloping protrusion (projection)
76 Planarizing layer
V1 First vertically-aligned part (boundary of orientational region)
V2 Second vertically-aligned part (boundary of orientational region)
V3 Third vertically-aligned part (boundary of orientational region)
V4 Fourth vertically-aligned part (boundary of orientational region)
V5 Fifth vertically-aligned part (boundary of orientational region)
L1 First line range (range overlapping electrode)
L2 Second line range (range overlapping electrode)
L3 Third line range (range overlapping electrode)
S1 First space range (range between comb teeth)
S2 Second space range (range between comb teeth)
R1 First orientational region (orientational region)
R2 Second orientational region (orientational region)
R3 Third orientational region (orientational region)
R4 Fourth orientational region (orientational region)

1. A liquid crystal display element, which is a vertical alignment type liquid crystal display element including a pair of substrates, and a liquid crystal layer containing liquid crystal molecules, the liquid crystal layer being sandwiched between the substrates and being configured to carry out display operation by controlling orientations of the liquid crystal molecules in the liquid crystal layer by use of transverse electric fields, comprising:
projections being provided in respective positions on a liquid crystal layer-side surface of at least one of the substrates, the respective positions corresponding to boundaries of orientational regions in the liquid crystal layer, each of said projections having a taper shape.

2. The liquid crystal display element as set forth in claim 1, wherein:
interleaved electrodes are provided on at least a first substrate; and
each of said projections is provided at a position which (i) is on a surface of a second substrate which surface faces the liquid crystal layer, and (ii) overlaps corresponding one of the interleaved electrodes on the first substrate when viewed from above, where either one of the substrates on which the interleaved electrodes are formed is referred to as the first substrate and the other one of the substrates which faces the first substrate is referred to as the second substrate.

3. The liquid crystal display element as set forth in claim 1, wherein:
interleaved electrodes are provided on at least the first substrate; and
each of said projections is provided at a position which (i) is on a surface of at least one of the first substrate and the second substrate which surface faces the liquid crystal layer, and (ii) is a position between two adjacent ones of the interleaved electrodes when viewed from above.

4. The liquid crystal display element as set forth in claim 1, further comprising:
color filters; and
a planarizing layer which covers said color filters,
said color filters and said planarizing layer being provided, in this order toward the liquid crystal layer, on at least one of the first substrate and the second substrate,
said projections being formed from said planarizing layer.

5. The liquid crystal display element as set forth in claim 1,
wherein: an angle formed between (i) a direction perpendicular to at least one of the first substrate and the second substrate on which said projections are provided, and (ii) each of directions in which two inclined surfaces of each of said projections extend is not smaller than 0° but not greater than 50°.

6. The liquid crystal display element as set forth in 5,
wherein the angle is not smaller than 6° but not greater than 25°.

7. The liquid crystal display element as set forth in claim 1,
wherein each of said projections has a height of not smaller than 0.5 μm but not greater than 50% of a thickness of the liquid crystal layer.

8. The liquid crystal display element as set forth in claim 1,
wherein two straight lines extended from two inclined surfaces of each of said projections intersect with each other on a corresponding one of the boundaries of the orientational regions.

9. The liquid crystal display element as set forth in claim 1,
wherein each of said projections has a trapezoidal cross-sectional shape.

10. The liquid crystal display element as set forth in claim 1,
wherein each of the orientational regions is a region sandwiched between two adjacent vertically-aligned parts.

11. A liquid crystal display device comprising, as a display section, a liquid crystal display element recited in claim 1.
